(19) United States
(12) Patent Application Publication
(10) Pub. No.: US 2026/0336290 A1
(43) Pub. Date: Oct. 29, 2026

(54) PRINTING ELEMENT SUBSTRATE AND PRINTING HEAD

(71) Applicant: CANON KABUSHIKI KAISHA, Tokyo (JP)

(72) Inventor: HIROYASU NOMURA, Tokyo (JP)

(21) Appl. No.: 19/653,880

(22) Filed: Apr. 21, 2026

(30) Foreign Application Priority Data
Apr. 25, 2025 (JP) 2025-073563

(51) Int. Cl. B41J 2/14; B41J 2/045

(52) U.S. Cl. CPC B41J 2/14153; B41J 2/04508; B41J 2/04563; B41J 2/0458; B41J 2/14072; B41J 2/04518; B41J 2/04523; B41J 2202/08

(57) ABSTRACT

A printing element substrate that ejects ink through a plurality of ejection ports by activating a heating element provided in association with each of the plurality of ejection ports includes a plurality of first temperature detecting elements capable of detecting a temperature from a change in potential difference between opposite ends, a plurality of second temperature detecting elements connected in series with at least one of the plurality of first temperature detecting elements and capable of detecting a temperature from a change in potential difference between opposite ends, a first selecting unit configured to select one of the plurality of first temperature detecting elements, and a first switch element configured to, according to a signal from the first selecting unit, energize the first temperature detecting element selected by the first selecting unit and energize a second temperature detecting element connected in series with the first temperature detecting element.

### BACKGROUND

### Field of the Technology

The present disclosure relates to a printing element substrate and a printing head.

### Description of the Related Art

Among inkjet printing systems that ejects ink from a nozzle onto a print medium, such as paper, a thermal inkjet printing system is known which uses thermal energy generated by a heater to eject ink from a nozzle.

Japanese Patent Laid-Open No. 2019-006108 discloses a technique of measuring the temperature of a printing element substrate of a thermal inkjet printing apparatus with temperature detecting diodes provided at a plurality of points in the printing element substrate.

Japanese Patent Laid-Open No. 2008-023987 discloses a technique of applying a constant current to a temperature detecting element disposed directly below a heater and obtaining potential signals at opposite terminals of the temperature detecting element, in order to detect the temperature of the heater.

### SUMMARY

An aspect of the present disclosure is directed to reduce a circuit area in printing element substrate of a thermal inkjet printing apparatus and reduce a substrate cost.

A printing element substrate according to an aspect of the present disclosure is a printing element substrate that ejects ink through a plurality of ejection ports by activating a heating element provided in association with each of the plurality of ejection ports to cause bubbling of the ink in a flow channel, comprising: a plurality of first temperature detecting elements each disposed in the printing element substrate in association with one of the plurality of heating elements and capable of detecting a temperature from a change in potential difference between opposite ends; a plurality of second temperature detecting elements disposed in the printing element substrate, connected in series with at least one of the plurality of first temperature detecting elements, and capable of detecting a temperature from a change in potential difference between opposite ends; a first selecting unit configured to select one of the plurality of first temperature detecting elements; and a first switch element configured to become a conductive state according to a signal from the first selecting unit to energize the first temperature detecting element selected by the first selecting unit and energize the second temperature detecting element connected in series with the first temperature detecting element selected by the first selecting unit.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing a control configuration of a substrate temperature inspection apparatus for controlling a printing element substrate;

FIG. 2 is a cross-sectional view schematically showing the printing element substrate and a flow channel configuration;

FIG. 3 is a diagram showing an example circuit configuration of the printing element substrate;

FIG. 4 is a timing chart showing how a logic circuit unit of the printing element substrate is driven;

FIG. 5 is a timing chart showing output waveforms of differential amplifier during normal ejection;

FIG. 6 is a diagram showing an example circuit configuration of a printing element substrate;

FIG. 7 is a diagram showing an example circuit configuration of a printing element substrate;

FIG. 8 is a diagram showing an example circuit configuration of a printing element substrate; and

FIG. 9 is a diagram showing an example circuit configuration of a printing element substrate.

### DESCRIPTION OF THE EMBODIMENTS

In the following, examples of embodiments of the present disclosure will be described with reference to the drawings. Note that the embodiments described below are not intended to limit the present disclosure, and all combinations of the features described in the embodiments described below are not necessarily essential for the solution of the present disclosure. Note that in the following description, the same components will be denoted by the same reference numerals.

### First Embodiment

### Overview

An overview of a first embodiment will be described. With a thermal inkjet printing apparatus, if the printing frequency varies with nozzle, the temperature distribution of the ejected ink is uneven, and the ink ejection amount of the nozzles is nonuniform. To correct the nonuniformity of the ejection amount due to the temperature distribution, a method has been introduced in which temperature detecting diodes are provided at a plurality of points in the printing element substrate for measuring temperature, and the temperature is controlled by adjusting the heating amount by the temperature adjusting heater such that the temperature of the substrate is uniform.

To increase the measurement precision of the substrate temperature obtained by the temperature detecting diodes, as described above, according to a known technique, temperature detecting diodes are provided at a plurality of points in the printing element substrate to measure the temperature of the substrate. According to such a technique, a constant current from a constant current source is applied to a desired temperature detecting diode based on a signal from a selecting circuit, the anode and the cathode of the temperature detecting diode are selected by other two selecting circuits, and the potential signals at the terminals are detected.

On the other hand, there is a known technique of applying a constant current to a temperature detecting element for detecting the temperature of a heater and obtaining output signals of potentials at both terminals of the temperature detecting element.

In a case of detecting both the temperature of the substrate and the temperature of the heater, the printing element substrate needs to be provided with both the temperature detecting diode and the temperature detecting element. The inventors have found through investigations that such a configuration has the problems described below. That is, in a case where both the temperature detecting diode and the temperature detecting element described above are provided in the printing element substrate, a sensor selecting circuit (referred to also as a first selecting unit) for selecting whether to apply a constant current needs to be provided for each of the temperature detecting diode and the temperature detecting element. Furthermore, the transistor used as a switch element that is turned on and off for applying the constant current to the temperature detecting diode and the temperature detecting element has a large area. Therefore, if the energization transistor is provided for each of the temperature detecting diode and the temperature detecting element, the circuit area increases. Thus, in the case where both the temperature detecting diode and the temperature detecting element are provided in the printing element substrate, the area of the sensor selecting circuit and the switch element increases, which is a factor in increasing the substrate cost.

In view of this, according to the present disclosure, in a printing element substrate of a thermal inkjet printing apparatus, a temperature detecting element and a temperature detecting diode are connected in series with each other so that a sensor selecting circuit and an energization switch element are shared. In this way, the circuit area can be reduced, and the substrate cost can be reduced.

### Control Configuration

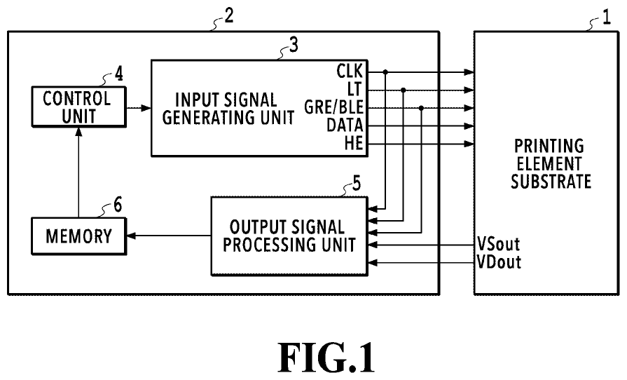

FIG. 1 is a block diagram showing a control configuration of a substrate temperature inspection apparatus 2 for controlling a printing element substrate 1. The substrate temperature inspection apparatus 2 includes an input signal generating unit 3, a control unit 4, an output signal processing unit 5 and a memory 6. The substrate temperature inspection apparatus 2 is control unit for controlling the printing element substrate 1. The substrate temperature inspection apparatus 2 may be implemented as an ASIC in a printing head, for example. Alternatively, the substrate temperature inspection apparatus 2 may be implemented as a control unit including a CPU and a memory (RAM) on the side of the printing apparatus main unit. Alternatively, some functions of the substrate temperature inspection apparatus 2 may be implemented by an ASIC incorporated in the printing head, and other functions may be implemented by hardware on the side of the printing apparatus main unit.

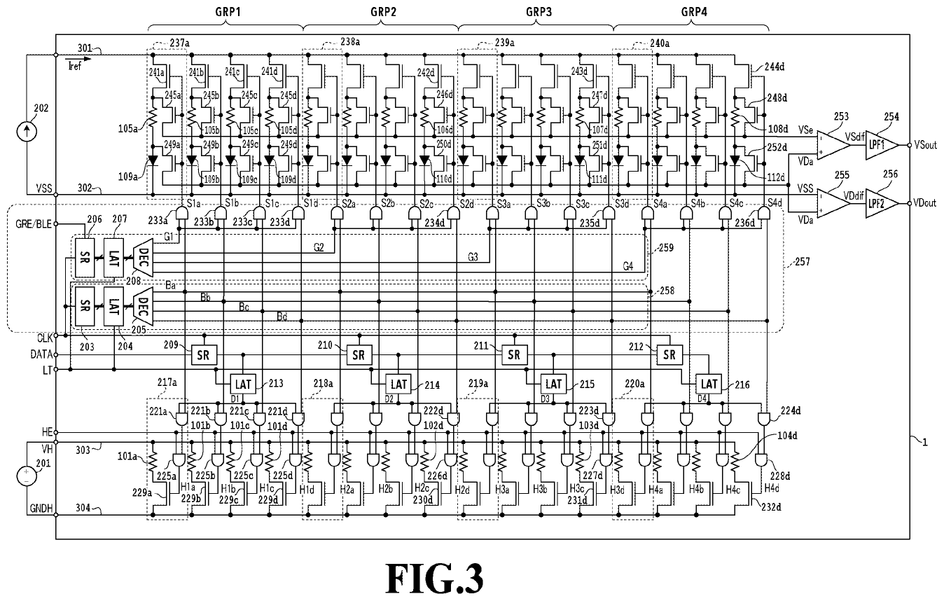

The input signal generating unit 3 receives an instruction from the control unit 4 and outputs various input signals to the printing element substrate 1. In this embodiment, the input signal generating unit 3 outputs a clock signal CLK, a latch signal LT, a block signal BLE, a group signal GRE, a heater selection signal DATA and a heat-enable signal HE. An output signal is transmitted to the printing element substrate 1 as an input signal to the printing element substrate 1. Of these signals, the block signal BLE and the heater selection signal DATA are used for selection of a heater 101. The block signal BLE and the group signal GRE are used for selection of a temperature sensor 105 and a temperature detecting diode 109 connected in series with the temperature sensor 105. Processing of signals input to the printing element substrate 1 will be described later with reference to FIG. 3. Note that the input signal generating unit 3 also outputs a sub-heater drive signal (not shown).

Of the signals output from the input signal generating unit 3, the clock signal CLK, the latch signal LT, the block signal BLE and the group signal GRE are also input to the output signal processing unit 5. Furthermore, the output signal processing unit 5 receives a sensor output signal VSout and a diode output signal VDout output from the printing element substrate 1, based on detection signals detected by the temperature sensor 105 and the temperature detecting diode 109.

The output signal processing unit 5 applies various kinds of filtering processing to the sensor output signal VSout and extracts an ejection determination result for each latch period in synchronization with the falling of the latch signal LT. In a case where the ejection determination result is an ejection failure, the output signal processing unit 5 records the block signal BLE and the group signal GRE corresponding to the determination result in the memory 6.

The output signal processing unit 5 performs digital conversion on the diode output signal VDout for each latch period in synchronization with the falling of the latch signal LT to extract diode temperature data, and records the diode temperature data in the memory 6.

In response to the block signal BLE and the group signal GRE for an ejection-failure nozzle recorded in the memory 6, in a case where a heater to be driven includes the ejection-failure nozzle, the control unit 4 deletes the ejection-failure nozzle from the heater selection signal DATA for the block. The control unit 4 then adds a nozzle as an ejection-failure nozzle replacement to the heater selection signal DATA for the block, and outputs the heater selection signal DATA to the input signal generating unit 3. The control unit 4 also generates a sub-heater drive signal for smoothing an unevenness in temperature from the diode temperature data recorded in the memory 6, and outputs the sub-heater drive signal to the input signal generating unit 3.

### Configuration of Printing Element Substrate

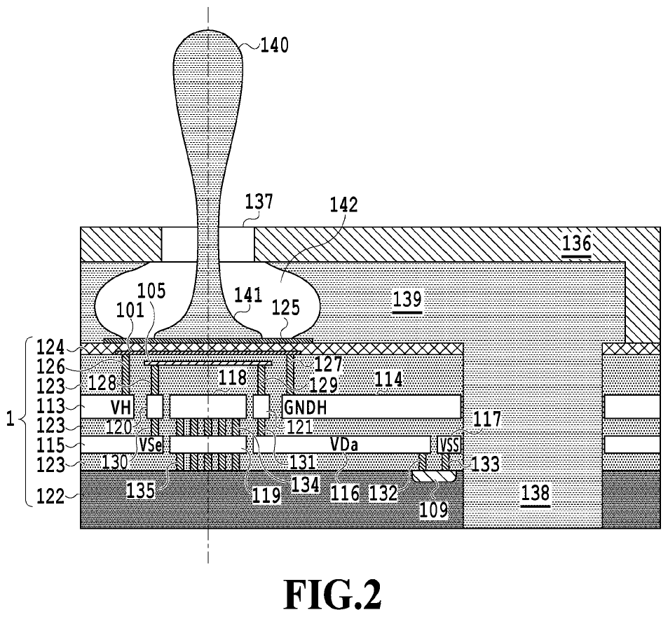

FIG. 2 is a cross-sectional view of one of a plurality of nozzles provided on the printing element substrate 1 according to this embodiment taken along a nozzle flow channel direction. In this embodiment, a heater 101 as a heating element is provided for each of a plurality of ejection ports. Ink is ejected from the ejection port by energizing the heater 101 for heating and thereby making the ink in the flow channel bubble. FIG. 2 shows an ink droplet normally ejected from the ejection port.

As shown in FIG. 2, the printing element substrate 1 includes a substrate 122, an insulating member 123, a protection film 124 and a cavitation-resistant film 125. The insulating member 123 includes a stack of a plurality of interlayer insulating films, and a plurality of wiring layers are provided between the plurality of interlayer insulating films. On the substrate 122, the temperature detecting diode 109 is formed, and the plurality of interlayer insulating films are stacked on the temperature detecting diode 109. Between the interlayer insulating films, the plurality of wiring layers and the temperature sensor 105 are provided in this order viewed from the side of the substrate 122. On the interlayer insulating films, that is, on the insulating member 123, the heater 101 is provided. The temperature sensor 105 and the temperature detecting diode 109 are electrically connected by a plurality of conductive plugs formed in the interlayer insulating films and a plurality of wiring patterns provided in the wiring layers between the stacked interlayer insulating films, as described later.

On the printing element substrate 1, an orifice plate 136 is provided. In the orifice plate 136, a nozzle flow channel 139, an ink supply port 138 and an ejection port 137 are formed. The ink supply port 138 is formed in a direction perpendicular to the nozzle flow channel 139 in the printing element substrate 1. One ejection port 137 is formed for each nozzle in the orifice plate 136. The printing head including the printing element substrate 1 is formed in this way.

For the substrate 122 forming the printing element substrate 1, a semiconductor material, such as silicon, can be used. On the substrate 122, the insulating member 123 is provided. The insulating member 123 incorporates two wiring layers as described later. The insulating member 123 includes a plurality of interlayer insulating films stacked on one another, wiring layers formed by a plurality of wiring patterns (113 to 116) formed between the interlayer insulating films, and a plurality of conductive plugs (126 to 133) formed to penetrate the interlayer insulating films. For the insulating member 123, an insulating material, such as silicon oxide, can be used.

The heater 101 (referred to also as a heating element) is provided on the insulating member 123 directly below the ejection port 137. As the heater 101, for example, a thin film resistor can be used that is made of a material that has a high specific resistance and is thermally stable, such as TaSiN. The shape of the heater 101 is not particularly limited, and the heater 101 may have a rectangular shape, for example.

The temperature sensor 105 (referred to also as a first temperature detecting element) is provided directly below the heater 101 above the wiring layers in the insulating member 123. That is, the temperature sensor 105 is provided directly below the heater 101 between interlayer insulating films stacked on wiring layers. The layer in which the temperature sensor 105 is provided is referred to as a sensor layer. The temperature sensor 105 can be provided in the vicinity of the heater 101 in the insulating member 123. The temperature sensor 105 is formed by a thin film resistor. For the temperature sensor 105, a material having a high specific resistance substantially equal to that of the heater 101 and a high temperature coefficient of resistance can be used in order to increase the output voltage.

The value of the electric resistance of the temperature sensor 105 (first temperature detecting element) varies with temperature. Therefore, a signal concerning temperature can be detected from a change in potential difference between opposite ends in a case where a constant current from a constant current source is applied to the temperature sensor 105.

The protection film 124 is formed to cover a top of the heater 101 and the insulating member 123. For the protection film 124, an insulating material, such as SiN, can be used. The cavitation-resistant film 125 is formed to cover a part of the protection film 124 directly below the ejection port 137. As the cavitation-resistant film, a Ta film can be used, for example.

The heater 101 and the temperature sensor 105 described above are electrically connected by the plurality of wiring patterns provided in the wiring layers and the plurality of conductive plugs provided in the interlayer insulating films, thereby forming a circuit capable of implementing a printing function. In this embodiment, an example will be described in which two wiring layers, a first wiring layer closest to the substrate 122 and a second wiring layer (a wiring layer closer to the heater) above the first wiring layer, are provided in total. However, the number of wiring layers is not limited to two, and a single wiring layer or a three or more wiring layers may be provided.

Next, a configuration of the wiring patterns and the conductive plugs provided in the insulating member 123 and an electrical connection of the printing elements will be described with reference to FIG. 2. The wiring layers include an interlayer insulating film formed on the substrate 122, the first wiring layer, an interlayer insulating film on the first wiring layer, the second wiring layer and an interlayer insulating film on the second wiring layer. On the insulating member 123, the heater 101 is provided. Furthermore, the temperature sensor 105 is provided between interlayer insulating films stacked directly below the heater 101.

The heater 101 is connected to a wiring pattern 113 of the second wiring layer via a conductive plug 126 at one short-side end. The heater 101 is also connected to a wiring pattern 114 of the second wiring layer via a conductive plug 127 at the other short-side end. Note that the wiring pattern 113 is connected to a power line (voltage VH) of a constant voltage source 201, and the wiring pattern 114 is grounded (GNDH) via switch elements 229 to 232 described later.

The temperature sensor 105 is connected to a pad 120 of the second wiring layer via a conductive plug 128 provided at one end, and also connected to a wiring pattern 115 of the first wiring layer via a conductive plug 130. The other end of the temperature sensor 105 is connected to a pad 121 of the second wiring layer via a conductive plug 129, and also connected to a wiring pattern 116 of the first wiring layer via a conductive plug 131.

The temperature detecting diode 109 (referred to also as a second temperature detecting element) is a pn junction diode formed in the substrate 122. An anode of the temperature detecting diode 109 is connected to a conductive plug 132, and a cathode of the temperature detecting diode 109 is connected to a conductive plug 133. The temperature detecting diode 109 is an element that detects temperature as with the temperature sensor 105, controls driving of the heater 101 and assists the printing function. Therefore, the heater 101, the temperature sensor 105 and the temperature detecting diode 109 form the printing element of the printing element substrate 1. The printing element substrate 1 has a configuration in which the printing element is mounted on the substrate 122.

The value of the electric resistance of the temperature detecting diode 109 (second temperature detecting element) varies with temperature (a forward voltage Vf of the diode varies). Therefore, a signal concerning temperature can be detected from a change in potential difference between opposite ends in a case where a constant current from a constant current source is applied to the temperature detecting diode 109.

The wiring pattern 115 is electrically connected to a current supply line of a constant current source 202 via energization switch elements 241 to 244, as described later. The wiring pattern 116 is connected to the anode of the temperature detecting diode 109 formed in the substrate 122 via the conductive plug 132. The cathode of the temperature detecting diode 109 is connected to the wiring pattern 117 of the first wiring layer via the conductive plug 133. Note that the wiring pattern 117 is grounded to a ground line (ground potential VSS) of the constant current source.

As described above, the other end of the temperature sensor 105 is connected to the anode of the temperature detecting diode 109 via the conductive plug 129, the pad 121, the conductive plug 131, the wiring pattern 116 and the conductive plug 132. That is, the temperature sensor 105 and the temperature detecting diode 109 are connected in series with each other. Therefore, the same constant current supplied from the power supply line of the constant current source 202 to the one end of the temperature sensor 105 is applied to the temperature sensor 105 and the temperature detecting diode 109 at the same time.

A heat dissipation pattern 118 is disposed in the second wiring layer below the heater 101. The heat dissipation pattern 118 is connected to a heat dissipation pattern 119 of the first wiring layer via a plug 134. Furthermore, the heat dissipation pattern 119 is connected to the substrate 122 via a plug 135. With such a configuration, in a case where the heater 101 is driven to generate heat and then stops being driven, the generated heat is quickly dissipated to the substrate 122.

Next, differences in thermal response between the temperature sensor 105 and the temperature detecting diode 109 involved with a behavior of an ink droplet 140 in a case where a drive pulse is applied to the heater 101 will be described.

In a case where a drive pulse of a voltage VH is applied to the heater 101, as shown in FIG. 2, film bubbling of ink occurs at the surface of the cavitation-resistant film 125 directly above the activated heater 101, and a bubble 142 expands. At the same time, the temperature sensor 105 disposed directly below the heater 101 is heated by the heater 101 and rapidly raised in temperature. On the other hand, the temperature detecting diode 109 provided in the surface of the substrate 122 is not significantly raised in temperature in a time scale of the order of microseconds, because the plurality of interlayer insulating films between the heater 101 and the temperature detecting diode 109 serve as a heat insulating wall.

As the bubble 142 expands, the ink droplet 140 is ejected through the ejection port 137, and then, the pressure of the bubble 142 having rapidly expanded becomes negative. The negative pressure of the bubble 142 acts on a tail 141 of the ink droplet 140. The tail 141 drawn into the nozzle flow channel 139 falls onto the surface of the cavitation-resistant film 125. In this way, the printing head according to this embodiment ejects ink through the ejection port 137 by activating the heater 101, which is a heating element, to cause bubbling of the ink in the flow channel.

In this process, the fallen tail 141 absorbs heat from the surface of the cavitation-resistant film 125, and the temperature sensor 105 is cooled and rapidly lowered in temperature. On the other hand, the falling of the tail 141 has little effect on the temperature change of the temperature detecting diode 109 in a time scale of the order of microseconds, since the interlayer insulating films serve as a heat insulating wall as described above. However, in a time scale of the order of milliseconds of the process of repeatedly applying drive pulses, the temperature detecting diode 109 and the ink in the ink supply port 138 are slowly raised in temperature because of the heat transferred through various heat dissipation paths. Therefore, the temperature of the ink supplied to the nozzle flow channel 139 can be satisfactorily kept track of by disposing the temperature detecting diode 109 in the vicinity of the side surface of the ink supply port 138.

On the other hand, the temperature sensor 105 is provided in the vicinity of the heater 101 in an interlayer insulating film 123c and thus can satisfactorily keep track of the temperature change associated with the state change of the surface of the cavitation-resistant film 125.

### Circuit Configuration

FIG. 3 is a block diagram showing a circuit configuration of the printing element substrate 1 according to this embodiment. In this embodiment, a nozzle array provided in the printing element substrate 1 is divided into four groups GRP1 to GRP4. Each group is formed by four nozzles. Each nozzle in a group belongs to a different one of blocks BLK1 to BLK4. Note that one nozzle belongs to one block. The same holds true for the heater 101, the temperature sensor 105, the temperature detecting diode 109 and switch elements provided in association therewith. In each group, reference numerals indicating elements of different blocks are added with different appendixes a, b, c and d, where the appendix a means an element belonging to the block BLK1, the appendix b means an element belonging to the block BLK2 and so on. In a case of indicating all of the four elements of one group, appendixes a, b, c and d are omitted.

In this embodiment, an example will be described in which sixteen nozzles are divided into four groups each including four nozzles, and the four nozzles in each group belong to four different blocks. However, the number of nozzles is not limited to this, and the present disclosure can be applied to a case where L nozzles are divided into N groups each including M nozzles, and the M nozzles in each group belong to M different blocks. Note that L, M and N denote natural numbers and satisfy a relation that L=M×N. The same holds true for the heater 101, the temperature sensor 105 and the temperature detecting diode 109. For example, for the temperature sensor 105, L temperature sensors 105 are provided for a nozzle array including L nozzles. The L temperature sensors 105 are formed by N groups each including M temperature sensors 105. Each of the M temperature sensors 105 in each group belongs to a different one of M different blocks.

The printing element substrate 1 includes a plurality of drive circuits 217 to 220, a plurality of temperature obtaining circuits 237 to 240, a sensor selecting circuit 257, a sensor signal processing circuit and a diode signal processing circuit. The printing element substrate 1 further includes shift registers 209 to 212, latch circuits 213 to 216 and wiring that connects these elements, for example. The printing element substrate 1 further includes an input/output unit (a pad or a terminal) for receiving a signal from the outside or outputting a signal to the outside. The input/output unit (pad or terminal) may be a terminal for receiving a signal, such as a clock signal CLK or a latch signal LT, from the outside or a terminal for outputting a sensor output signal VSout or a diode output signal VDout to the outside, for example.

A drive circuit 217a in the printing element substrate 1 is formed by a heater 101a, a switch element 229a, an AND gate circuit 221a and an AND gate circuit 225a as shown in FIG. 3. Drive circuits 217b to 217d and drive circuits 218 to 220 have a similar configuration.

A temperature obtaining circuit 237a is formed by a temperature sensor 105a, a temperature detecting diode 109a, and a constant current application switch element 241a. The temperature detecting diode 109 is connected in series with the temperature sensor 105 associated therewith (the temperature sensor 105 belonging to the same block). Temperature obtaining circuits 237b to 237d and temperature obtaining circuits 238 to 240 have a similar configuration.

The sensor selecting circuit 257 (referred to also as a first selecting unit) includes a group selecting circuit 259 (referred to also as a second selecting unit) and a block selecting circuit 258 (referred to also as a third selecting unit), as described later. Configurations of the group selecting circuit 259 and the block selecting circuit 258 and an operation of a logic circuit that generates a selection signal will be described later.

The sensor signal processing circuit (referred to also as a first signal processing unit) is formed by a differential amplifier 253 (referred to also as a first differential amplifier). The diode signal processing circuit (referred to also as a second signal processing unit) is formed by a differential amplifier 255 (referred to also as a second differential amplifier). The differential amplifier 253 amplifies and outputs the difference between signals input to two input terminals. The same holds true for the differential amplifier 255. The output signal of the differential amplifier 253 is input to a low pass filter circuit 254 (referred to also as a first low pass filter circuit). The output signal of the differential amplifier 255 is input to a low pass filter circuit 256 (referred to also as a first low pass filter circuit).

In this embodiment, an example will be described in which the constant voltage source 201 for driving the heaters 101 to 104 and the constant current source 202 for energizing the temperature sensors 105 to 108 and the temperature detecting diodes 109 to 112 are disposed outside of the printing element substrate 1 as shown in FIG. 3. Of these sources, the constant current source 202 may include a constant current circuit incorporated in the printing element substrate 1. In that case, although the constant voltage source serving as a power supply of the constant current circuit is disposed outside of the printing element substrate 1, the constant current circuit that generates a constant current from the constant voltage is incorporated in the printing element substrate 1.

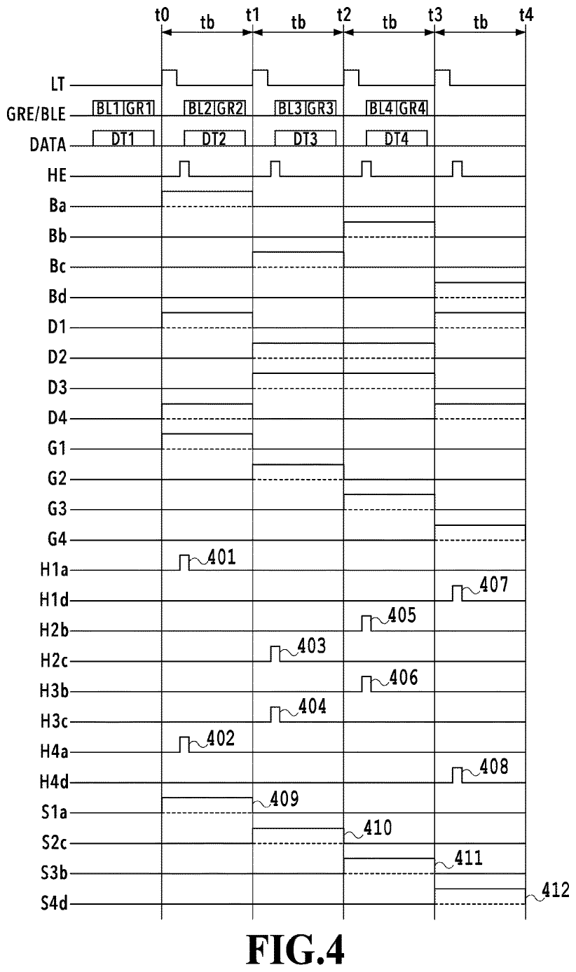

In the following, operations of circuits according to this embodiment will be described. Note that the operation of the logic circuit including the sensor selecting circuit 257 will be described in detail later with reference to the timing chart of FIG. 4. The constant current source 202 generates a constant current Iref by using a constant voltage source (not shown) and the constant current circuit. A current supply line of the constant current source 202 is connected to power supply wiring 301 in the printing element substrate 1. A ground line of the constant current source 202 is connected to grounding wiring 302 in the printing element substrate 1. The power supply wiring 301 is configured to apply a constant current to the temperature sensors 105 to 108 and the temperature detecting diodes 109 to 112. Here, one temperature sensor 105 to 108 and one temperature detecting diode 109 to 112 are provided for each nozzle. The temperature sensor 105 to 108 and the temperature detecting diode 109 to 112 belonging to the same block are connected in series with each other. Specifically, the temperature sensor 105a and the temperature detecting diode 109a are connected in series with each other. Therefore, the same constant current Iref is applied to the temperature sensor 105a and the temperature detecting diode 109a. The same holds true for the temperature sensors 105b to 105d and the temperature sensors 106 to 108 and the temperature detecting diodes 109b to 109d and the temperature detecting diodes 110 to 112.

The constant voltage source 201 supplies a drive current to the heaters 101 to 104. The power supply line (voltage VH) of the constant voltage source is connected to power supply wiring 303 in the printing element substrate 1. A ground line of the constant voltage source is connected to grounding wiring 304 in the printing element substrate 1. The power supply wiring 303 is connected to each of the heaters 101 to 104 and configured to apply a drive current to each of the heaters 101 to 104.

Next, an operation of the drive circuits 217 to 220 will be described. In the group GRP1, a switch element 229a forms one drive circuit 217a together with a heater 101a and AND gate circuits 221a and 225a, and controls application of a voltage from the constant voltage source 201 to the heater 101a. Here, in this embodiment, an example is shown in which a metal oxide semiconductor (MOS) transistor is used as the switch element 229. The source and the drain of the MOS transistor serving as the switch element can be switched between a conductive state and a non-conductive state by a signal input to the gate. Note that the switch element becoming the conductive state is referred to also as the switch element being turned on. Similarly, the switch element becoming the non-conductive state is referred to also as the switch element being turned off. The same holds true for the other switches in this embodiment.

In a case where the switch element 229a is turned on, the switch element 229a becomes the conductive state, so that the voltage VH of 24 V, for example, is applied to a high voltage-side of the heater 101a, and a low voltage-side of the heater 101a is grounded to GNDH via the switch element 229a. As a result, the drive current from the constant voltage source 201 flows through the heater 101a. On the other hand, in a case where the switch element 229a is turned off, the switch element 229a becomes the non-conductive state, so that no drive current flows to the heater 101a. The drive current to the other three heaters 101b to 101d is controlled by the switch elements 229b to 229d in the same manner. The operation of the drive circuit 217 in the GRP1 holds true for the drive circuits 218 to 220 in the other groups GRP2 to GRP4.

Next, an operation of the temperature obtaining circuits 237 to 240 will be described. In the block BLK1 in the group GRP1, the temperature sensor 105a and the temperature detecting diode 109a form one temperature obtaining circuit 237a together with a switch element 241a, a switch element 245a and a switch element 249a. In other words, the temperature obtaining circuit 237a is formed by the temperature sensor 105a, the temperature detecting diode 109a, the switch element 241a, the switch element 245a and the switch element 249a. The switch element 241a (referred to also as a first switch element) is connected between the power supply wiring 301 and an energization-side terminal of the temperature sensor 105a. A terminal of the temperature sensor 105a on the opposite side to the constant current application-side terminal is connected to the anode of the temperature detecting diode 109a. The cathode of the temperature detecting diode 109a is connected to the grounding wiring 302. That is, the temperature sensor 105a and the temperature detecting diode 109a belonging to the same block BLK1 are connected in series with each other. The switch element 241a controls application of the constant current Iref to the temperature sensor 105a and the temperature detecting diode 109a connected in series with each other. Specifically, the switch element 241a switches between the conductive state and the non-conductive state according to a signal from the sensor selecting circuit 257. Thus, by the switch element 241a being turned on to becoming the conductive state according to a signal from the sensor selecting circuit 257, the constant current Iref can be applied to the temperature sensor 105a and the temperature detecting diode 109a connected in series with the temperature sensor 105a.

With the configuration of the temperature obtaining circuit 237a according to this embodiment, in a case where the signal from the sensor selecting circuit 257 is true (High active), the switch element 241a is turned on and becomes the conductive state. Then, the constant current Iref is applied to the temperature sensor 105a and the temperature detecting diode 109a connected in series with the temperature sensor 105a. On the other hand, in a case where the signal from the sensor selecting circuit 257 is not true, the switch element 241a is turned off and becomes the non-conductive state. Then, the constant current Iref is not applied to the temperature sensor 105a and the temperature detecting diode 109a connected in series with the temperature sensor 105a. That is, the switch element 241a is an energization switch element that controls turning on and off of application of the constant current Iref to the temperature sensor 105a and the temperature detecting diode 109a.

Since the temperature sensor 105a and the temperature detecting diode 109a are connected in series with each other as described above, the temperature sensor 105a and the temperature detecting diode 109a can share the constant current application switch element 241a. That is, by outputting a signal that is true (High active) to wiring S1a connected to the gate of the switch element 241a, the constant current Iref can be applied to the temperature sensor 105a and the temperature detecting diode 109a. Therefore, the sensor selecting circuit 257 that outputs the signal for controlling turning on and off of the switch element 241a can also be shared by the temperature sensor 105a and the temperature detecting diode 109a connected in series with each other.

In the following, terminals of the pair of the temperature sensor 105a and the temperature detecting diode 109a connected in series with each other will be denoted as follows. That is, the temperature sensor 105a has a first terminal that is a constant current application-side terminal and connected to the power supply wiring 301 via the switch element 245a and a second terminal connected to the temperature detecting diode 109a. On the other hand, the temperature detecting diode 109a has a third terminal connected to the second terminal of the temperature sensor 105a and a fourth terminal that is a terminal on the opposite side to the third terminal. Here, the second terminal and the third terminal are electrically connected to each other and therefore have the same potential. Furthermore, in this embodiment, the third terminal is the anode of the temperature detecting diode 109a, and the four terminal is the cathode of the temperature detecting diode 109a.

The switch element 245a (referred to also as a second switch element) controls turning on and off of output of a potential signal VSe occurring at the constant current application-side terminal (first terminal) of the temperature sensor 105a to the differential amplifier 253 (an input signal to the inverting input terminal of the differential amplifier 253). That is, the switch element 245a is a switch element that extracts and detects the potential signal VSe occurring at the constant current application-side terminal (first terminal) of the temperature sensor 105a. The switch element 245a is connected between the constant current application-side terminal (first terminal) of the temperature sensor 105a and the differential amplifier 253. The switch element 245a switches between the conductive state and the non-conductive state according to the signal from the sensor selecting circuit 257, thereby controlling turning on and off of the output signal to the differential amplifier 253.

Similarly, switch element 249a (referred to also as a third switch element) controls turning on and off of output of a potential signal VDa occurring at the anode (third terminal) of the temperature detecting diode 109a to the differential amplifier 255 (an input signal to the non-inverting input terminal of the differential amplifier 255). The switch element 249a is a switch element that extracts and detects the potential signal VDa occurring at the anode (third terminal) of the temperature detecting diode 109a. The switch element 249a is connected between the anode (third terminal) of the temperature detecting diode 109a and the differential amplifier 255. The switch element 249a switches between the conductive state and the non-conductive state according to the signal from the sensor selecting circuit 257, thereby controlling turning on and off of the output signal to the differential amplifier 255.

The switch element 241a, the switch element 245a and the switch element 249a are configured to be turned on in synchronization. That is, the detection signal is output to the differential amplifier 253 and the differential amplifier 255 in synchronization with the energization of the temperature sensor 105a and the temperature detecting diode 109a connected in series with each other. In other words, turning on and off of the switch element 245a and the switch element 249a associated with the pair of temperature sensor 105a and the temperature detecting diode 109a connected in series with each other are in synchronization with turning on and off of the energization switch element 241a. As shown in FIG. 3 showing a specific circuit configuration, all of the gates of the switch element 241a, the switch element 245a and the switch element 249a are connected to the wiring S1a. Therefore, by outputting a signal that is true (High active) from an AND gate circuit 233a in the sensor selecting circuit 257 to the wiring S1a, the switch element 241a, the switch element 245a and the switch element 249a are turned on in synchronization. Therefore, the temperature sensor 105a and the temperature detecting diode 109a can share the sensor selecting circuit 257.

When the switch element 245a is turned on, the temperature sensor 105a outputs a detection signal concerning a temperature corresponding to the heater 101a to the differential amplifier 253. The “detection signal concerning a temperature corresponding to the heater 101a” means a detection signal concerning a temperature indicating the ejection state of the ink droplet 140 ejected from the nozzle associated with the heater 101a. When the switch element 249a is turned on, the temperature detecting diode 109a outputs a detection signal concerning the ink temperature in the ink supply port 138 to the differential amplifier 255. The other three temperature sensors 105b to 105d and the other three temperature detecting diodes 109b to 109d are controlled by the associated switch elements in the same manner.

In this embodiment, as described above, the temperature sensor 105a and the temperature detecting diode 109a can also share the sensor selecting circuit 257 for controlling turning on and off of the switch element 245a and the switch element 249a for extracting the detection signals from the temperature sensor 105a and the temperature detecting diode 109a, respectively. Note that the heaters 102 to 104, the temperature sensors 106 to 108 and the temperature detecting diodes 110 to 112 in the other groups GRP2 to GRP4 are also controlled by the associated switch elements, as in the group GRP1.

The differential amplifier 253 forming the sensor signal processing circuit processes a signal based on the potential difference between the opposite ends of the temperature sensors 105 to 108. As described above, the temperature sensors 105 to 108 can detect the signal concerning temperature from the change in potential difference between the opposite ends in a case where the constant current from the constant current source is applied to the temperature sensors 105 to 108. For example, a signal occurring at the constant current application-side terminal (first terminal) of the temperature sensor 105a and a signal occurring at the terminal (second terminal) of the temperature sensor 105a connected to the temperature detecting diode 109a are input signals to the differential amplifier 253. The differential amplifier 253 outputs a signal generated based on the signal occurring at the constant current application-side terminal (first terminal) of the temperature sensor 105a and the terminal (second terminal) of the temperature sensor 105a connected to the temperature detecting diode 109a. In this way, the signal concerning the temperature of the temperature sensor 105a can be detected. The same holds true for the other temperature sensors 105b to 105d and 106 to 108.

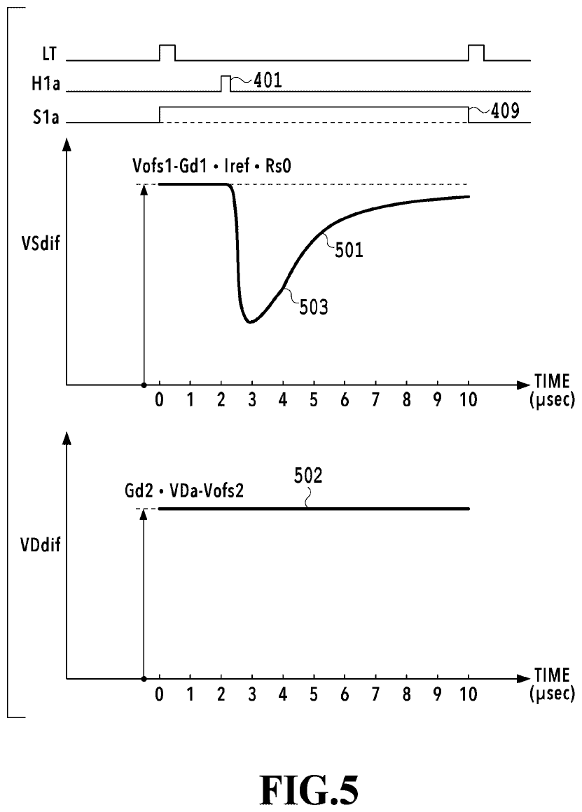

The differential amplifier 255 forming the diode signal processing circuit processes a signal based on the potential difference between the opposite ends of the temperature detecting diodes 109 to 112. As described above, the temperature detecting diodes 109 to 112 can detect the signal concerning temperature from the change in potential difference between the opposite ends in a case where the constant current from the constant current source is applied to the temperature detecting diodes 109 to 112. For example, a signal occurring at the anode (third terminal) of the temperature detecting diode 109a and a signal occurring at the cathode (fourth terminal) of the temperature detecting diode 109a are input signals to the differential amplifier 255. The differential amplifier 255 outputs a signal generated based on the signal occurring at the anode (third terminal) of the temperature detecting diode 109a and the signal occurring at the cathode (fourth terminal) of the temperature detecting diode 109a. In this way, the signal concerning the temperature of the temperature detecting diode 109a can be detected. The same holds true for the other temperature detecting diodes 109b to 109d and 110 to 112. Note that the operations of the differential amplifier 253 and the differential amplifier 255 will be described later with reference to FIG. 5.

Next, an operation of the sensor selecting circuit 257 will be described. The sensor selecting circuit 257 includes the block selecting circuit 258 and the group selecting circuit 259. The sensor selecting circuit 257 further includes AND gate circuits 233 to 236.

The block selecting circuit 258 is formed by a shift register 203, a latch circuit 204, a decoder 205 and wiring Ba to Bd. The block selecting circuit 258 outputs a block selection signal to the wiring Ba to Bd based on the block signal BLE. That is, the block selecting circuit 258 outputs a block selection signal that selects one of M blocks.

The group selecting circuit 259 is formed by a shift register 206, a latch circuit 207, a decoder 208, and wiring G1 to G4. The group selecting circuit 259 outputs a group selection signal to the wiring G1 to G4 based on the group signal GRE. That is, the group selecting circuit 259 outputs a group selection signal that selects one of N groups. The sensor selecting circuit 257 selects one of the plurality of temperature sensors 105 to 108 by outputting the group selection signal from the group selecting circuit 259 and the block selection signal from the block selecting circuit 258.

The AND gate circuits 233 to 236 outputs a logical product of the block selection signal and the group selection signal as a sensor selection signal to wiring S1 to S4. The sensor selection signal switches turning on and off of the switch elements 241 to 252 in the temperature obtaining circuits 237 to 240. Note that the block selection signal is also used for generating a heater drive signal that switches turning on and off of the switch elements 229 to 232 that apply a drive voltage to the heaters 101 to 104. That is, the block selecting circuit 258 is also a block selecting circuit for the heaters 101 to 104.

### Operation of Logic Circuits

FIG. 4 is a timing chart showing timings of the control of logic circuits of the printing element substrate 1 during operation. The “logic circuits of the printing element substrate 1” mean the sensor selecting circuit 257, the shift registers 209 to 212, the latch circuits 213 to 216, and the AND gate circuits 221 to 228. The timing chart of FIG. 4 shows the clock signal CLK, the latch signal LT, the block signal BLE and the group signal GRE input from the outside of the printing element substrate 1, the heater selection signal DATA and the heat-enable signal HE. In FIG. 4, a period from t0 to t1 is referred to as a first block period, a period from t1 to t2 is referred to as a second block period, a period from t2 to t3 is referred to as a third block period, and a period from t3 to t4 is referred to as a fourth block period. In the following, with reference to FIGS. 3 and 4, operations of the logic circuits of the printing element substrate 1 according to this embodiment will be described.

The printing element substrate 1 receives a clock signal CLK, a latch signal LT, a block signal BLE and a group signal GRE transferred from the substrate temperature inspection apparatus 2, a heater selection signal DATA that is 4-bit serial data, and a heat-enable signal (HE). Note that the block signal BLE and the group signal GRE form 4-bit serial data in combination.

The signals other than the clock signal CLK are received at block cycles tb. That is, the sixteen drive circuits 217 to 220 and the sixteen temperature obtaining circuits 237 to 240 are controlled in four blocks in a time division manner. By repeating this four times, temperature signals from the sixteen temperature sensors 105 to 108 and the sixteen temperature detecting diodes 109 to 112 are obtained.

Block signals BL1 to BL4 are transferred to the shift register 203 in synchronization with clock signals CLK. The transferred block signals BL1 to BL4 are latched in the latch circuit 204 at timings t0 to t3, respectively, decoded by the decoder 205 and then output to the wiring Ba to Bd.

Similarly, group signals GR1 to GR4 are also transferred to the shift register 206. The transferred group signals GR1 to GR4 are latched in the latch circuit 207 at the timings t0 to t3, respectively, decoded by the decoder 208 and then output to the wiring G1 to G4. Note that in this embodiment, the shift registers 203 and 206 are 2-bit registers.

The signals on the wiring Ba to Bd and the wiring G1 to G4 are retained for the time period tb until the subsequent latch timing, and in the meantime, the subsequent block signals and group signals are transferred to the shift register 203 and the shift register 206.

The signals on the wiring Ba to Bd are signals that make any one of the four pieces of wiring enabled (High active), and are used for selecting the heaters 101 to 104 to be driven at the same time in the period of the block cycle tb. The signals are further used for selecting the temperature sensors 105 to 108 and the temperature detecting diodes 109 to 112 in the same period.

In this embodiment, a case will be described in which the wiring is driven or selected in a time division manner such that the wiring Ba is enabled in the first block period, the wiring Bc is enabled in the second block period, the wiring Bb is enabled in the third block period, and the wiring Bd is enabled in the fourth block period as shown in FIG. 4.

Heater selection signals DT1 to DT4 are transferred to the shift registers 209 to 212 in synchronization with clock signals CLK. The transferred heater selection signals DT1 to DT4 are latched in the latch circuits 213 to 216 at the timings t0 to t3, respectively, and output to wiring D1 to D4. The signals on the wiring D1 to D4 are retained for the time period tb until the subsequent latch timing, and in the meantime, the subsequent heater selection signals are transferred to the shift registers 209 to 212.

The signals on the wiring D1 to D4 are used for selection from among the groups GRP1 to GRP4 of heaters to be driven. Referring to FIG. 3, the wiring D1 is connected to the AND gate circuits 221a to 221d. Therefore, in a case where the signal on the wiring D1 is true (which means High active. The same holds true for the following description), the heaters 101a to 101d of the group GRP1 can be selected.

Similarly, in a case where the signal on the wiring D2 is true, the heaters 102a to 102d of the group GRP2 can be selected. In a case where the signal on the wiring D3 is true, the heaters 103a to 103d can be selected. In a case where the signal on the wiring D4 is true, the heaters 104a to 104d can be selected.

In this embodiment, a case will be described in which the heaters of the groups GRP1 and GRP4 are selected in the first block period and the fourth block period, and the heaters of the groups GRP1 and GRP4 are selected in the second block period and the third block period. That is, a case will be described in which two heaters are driven in one block period, and eight heaters are driven in total in the four block periods.

In the first block period, the signal on the wiring Ba that is true and the signals on the wiring D1 and D4 that are true are input to the AND gate circuits 221a and 224a. Output signals of the AND gate circuits 221a and 224a are input to the AND gate circuits 225a and 228a, respectively, together with the heat-enable signal HE. The AND gate circuits 225a and 228a output pulse signals 401 and 402 to wiring H1a and H4a, respectively. The wiring H1a and H4a are connected to the switch elements 229a and 232a, respectively, and the heaters 101a and 104a are driven by the pulse signals 401 and 402, respectively.

Similarly, in the second block period, the AND gate circuits 226c and 227c output pulse signals 403 and 404 to wiring H2c and H3c, respectively. The wiring H2c and H3c are connected to the switch elements 230c and 231c, respectively, and the heaters 102c and 103c are driven by the pulse signals 403 and 404, respectively.

Similarly, in the third block period, the heaters 102b and 103b are driven by pulse signals 405 and 406, respectively. In the fourth block period, the heaters 101d and 104d are driven by pulse signals 407 and 408, respectively.

The signals on the wiring G1 to G4 are signals that enable any one of the four pieces of wiring and are used for selecting one of the groups GRP1 to GRP4 that includes the temperature sensors associated with the heaters to be driven. That is, one of the signals on the wiring G1 to G4 that corresponds to the group selected by one of the signals on the wiring D1 to D4 enabled in one block period must be true.

In FIG. 3, the wiring G1 is connected to the AND gate circuits 233a to 233d. Therefore, in a case where the signal on the wiring G1 is true, the temperature sensors 105a to 105d of the group GRP1 can be selected as temperature sensors associated with the heaters to be driven.

Similarly, in a case where the signal on the wiring G2 is true, the temperature sensors 106a to 106d of the group GRP2 can be selected as temperature sensors associated with the heaters to be driven. In a case where the signal on the wiring G3 is true, the temperature sensors 107a to 107d can be selected as temperature sensors associated with the heaters to be driven. In a case where the signal on the wiring G4 is true, the temperature sensors 108a to 108d can be selected as temperature sensors associated with the heaters to be driven.

In this embodiment, a case will be described in which in the first block period, the signal on the wiring G1 associated with the signal on the wiring D1, among the signals on the wiring D1 and D4 that are true, is true so that the temperature sensors of the group GRP1 are selected as shown in FIG. 4. Similarly, in the second block period, the signal on the wiring G2 is true so that the temperature sensors of the group GRP2 are selected. In the third block period, the signal on the wiring G3 is true so that the temperature sensors of the group GRP3 are selected. In the fourth block period, the signal on the wiring G4 is true so that the temperature sensors of the group GRP4 are selected.

Since the temperature sensors associated with the heaters to be driven need to be selected in one block period, the signals on the wiring Ba to Bd are used as the block signals for selecting the temperature sensors, as with the case of selecting the heaters to be driven. That is, in the first block period, the signals on the wiring Ba to Bd are input to the AND gate circuits 233a to 233d, respectively, together with the signal on the wiring G1. As a result, the AND gate circuit 233a outputs a pulse signal 409 that is true to the wiring S1a. The wiring S1a is connected to the switch element 241a, and in response to the pulse signal 409, the constant current Iref from the constant current source 202 is applied to the temperature sensor 105a through the switch element 241a. At the same time, the constant current Iref is applied to the temperature detecting diode 109a connected in series with the temperature sensor 105a.

The wiring S1a is also connected to the switch elements 245a and 249a. Therefore, the potential signal VSe that occurs at the constant current application-side terminal (first terminal) of the temperature sensor 105a is output to the inverting input terminal of the differential amplifier 253 through the switch element 245a. The potential signal VSe is output to the inverting input terminal of the differential amplifier 253 in order to effectively use the output range of the differential amplifier 253 on the assumption that the temperature sensor has a positive temperature characteristic. Note that the “positive temperature characteristic” means a temperature characteristic that the resistance increases as the temperature rises.

The potential signal VDa that occurs at the anode (third terminal) of the temperature detecting diode 109a is output to the non-inverting input terminals of the differential amplifiers 253 and 255 through the switch element 249a. The potential signal VDa is output to the non-inverting input terminal of the differential amplifier 255 in order to effectively use the output range of the differential amplifier 255 on the assumption that the temperature detecting diode has a negative temperature characteristic. Note that the “negative temperature characteristic” means a temperature characteristic that the resistance decreases as the temperature rises.

Similarly, in the second block period, the AND gate circuit 234c outputs a pulse signal 410 that is true to wiring S2c. The wiring S2c is connected to the switch elements 242c, 246c and 250c, so that in response to the pulse signal 410, the constant current Iref is applied to the temperature sensor 106c and the temperature detecting diode 110c through the switch element 242c.

Furthermore, the potential signal VSe that occurs at the constant current application-side terminal (first terminal) of the temperature sensor 106c is output to the inverting input terminal of the differential amplifier 253 through the switch element 246c. Furthermore, the potential signal VDa that occurs at the anode (third terminal) of the temperature detecting diode 109a is output to the non-inverting input terminals of the differential amplifiers 253 and 255 through the switch element 250c.

In the third block period, the AND gate circuit 235b outputs a pulse signal 411 that is true to wiring S3b. The wiring S3b is connected to the switch elements 243b, 247b and 251b, so that in response to the pulse signal 411, the constant current Iref is applied to the temperature sensor 107b and the temperature detecting diode 111b through the switch element 243b.

Furthermore, the potential signal VSe that occurs at the constant current application-side terminal (first terminal) of the temperature sensor 107b is output to the inverting input terminal of the differential amplifier 253 through the switch element 247b. Furthermore, the potential signal VDa that occurs at the anode (third terminal) of the temperature detecting diode 111b is output to the non-inverting input terminals of the differential amplifiers 253 and 255 through the switch element 251b.

In the fourth block period, the AND gate circuit 236d outputs a pulse signal 412 that is true to wiring S4d. The wiring S4d is connected to the switch elements 244d, 248d and 252d, so that in response to the pulse signal 412, the constant current Iref is applied to the temperature sensor 108d and the temperature detecting diode 112d through the switch element 244d.

Furthermore, the potential signal VSe that occurs at the constant current application-side terminal (first terminal) of the temperature sensor 108d is output to the inverting input terminal of the differential amplifier 253 through the switch element 248d. Furthermore, the potential signal VDa that occurs at the anode (third terminal) of the temperature detecting diode 112d is output to the non-inverting input terminals of the differential amplifiers 253 and 255 through the switch element 252d. Note that throughout all the block periods, a ground potential VSS at a common terminal of the cathodes (fourth terminals) of the temperature detecting diodes 109 to 112 is input to the inverting input terminal of the differential amplifier 255.

FIG. 5 is a timing chart showing output waveforms of the differential amplifiers 253 and 255 during normal ejection in the first block period shown in FIG. 4. The timing charts for the other block periods are the same as the timing chart for the first block period and therefore will not be described here. In the following, with reference to FIGS. 3 and 5, operations of the differential amplifiers 253 and 255 of the printing element substrate 1 according to this embodiment will be described.

The potential signal VDa that occurs at the anode (third terminal) of the temperature detecting diode 109a is input to the non-inverting input terminal of the differential amplifier 253, and the potential signal VSe that occurs at the constant current application-side terminal (first terminal) of the temperature sensor 105a is input to the inverting input terminal of the differential amplifier 253. The differential amplifier 253 amplifies the difference between these two input signals with an amplification factor Gd1, raises the amplified difference with an offset voltage Vofs1, and outputs the resulting signal as an output signal VSdif. This is expressed by the following formula (1).

VSdif=Gd1*(VDa−VSe)+Vofs1 (1)

Provided that the temperature and the resistance of the temperature sensor 105a are denoted as Ts and Rs, respectively, and the initial temperature, the initial resistance and the temperature coefficient of resistance before driving of the heater are denoted as Ts0, Rs0 and TCR (positive), respectively, the potential signal VSe is expressed by the following formula (2).

VSe=VDa+Iref*Rs=VDa+Iref*Rs0*[1+TCR*(Ts−Ts0)] (2)

Substituting the formula (2) into the formula (1) yields the following formula (3).

VSdif=Vofs1−Gd1*Iref*Rs0*[1+TCR*(Ts−Ts0)]

As shown by a waveform 501 of the output signal VSdif of the differential amplifier 253 in FIG. 5, before application of the pulse signal 401 (drive pulse for the heater 101a) to the heater 101a, the sensor temperature Ts is equal to the initial temperature Ts0. Therefore, according to the formula (3), the output signal VSdif of the differential amplifier 253 is a constant voltage VSdif0 expressed by the following formula.

Vsdif0=Vofs1−Gd1*Iref*Rs0 (4)

When the pulse signal 401 is turned on, the sensor temperature Ts rapidly rises, so that the output signal VSdif is rapidly lowered. When the pulse signal 401 is turned off, the sensor temperature Ts is gradually lowered because of heat dissipation, and the output signal VSdif begins to rise. Then, at a timing 503 when the tail 141 of the ink droplet 140 falls onto the cavitation-resistant film 125, a point of inflection occurs in the waveform 501, and the temperature drop rate of the temperature sensor 105a increases, and the rise of the output signal VSdif is also accelerated.

On the other hand, the potential signal VDa is input to the non-inverting input terminal of the differential amplifier 255, and the ground potential VSS at the cathode (fourth terminal) of the temperature detecting diode 109a is input to the inverting input terminal of the differential amplifier 255. Since VSS normally equals to 0 V, the differential voltage between the two input signals is VDa. The differential amplifier 255 amplifies this voltage with an amplification factor Gd2, raises the amplified voltage with an offset voltage Vofs2 and outputs the resulting signal as the output signal VDdif. This is expressed by the following formula (5).

Vddif=Gd2*Vda−Vofs2 (5)

As described above with reference to FIG. 2, in a time scale of the order of microseconds, the output of the temperature detecting diode is not significantly thermally affected by the driving of the heater 101a and the falling of the tail 141. Therefore, a waveform 502 of the output signal VDdif of the differential amplifier 255 is substantially flat as shown in FIG. 5.

As shown in FIG. 3, the output signal VSdif of the differential amplifier 253 with high-frequency noise removed by the low pass filter circuit 254 is output as the sensor output signal VSout from the printing element substrate 1. Similarly, the output signal VDdif of the differential amplifier 255 with high-frequency noise removed by the low pass filter circuit 256 is output as the diode output signal VDout from the printing element substrate 1.

As described above, in this embodiment, the control sequence for the logic circuit unit of the printing element substrate 1 is performed in four block periods in a time division manner. By repeating a similar control sequence four times, the temperature signals of the sixteen temperature sensors 105 to 108 and the sixteen temperature detecting diodes 109 to 112 are obtained.

In this embodiment, as an example, a printing-in-progress inspection has been described in which temperature signals are obtained during printing from two nozzles in each block period. However, during printing, a ringing noise is superimposed on the input signals to the differential amplifier due to a change in rising and falling of the drive pulse for the heater. The ringing noise may be unable to be sufficiently cancelled by taking the difference between the signals and remain on the waveforms 501 and 502 (not shown in FIG. 5).

To avoid such a noise superimposition phenomenon, the inspection sequence may be modified such that temperature signals are obtained after the printing sequence of the printing element substrate 1 ends. In that case, however, the heater associated with the temperature sensor to be inspected needs to be driven, so that noise caused by driving of the heater for one nozzle in each block period is superimposed on the waveforms 501 and 502.

In view of this, the inspection sequence can be modified as follows. That is, after the printing sequence ends, all the four bits of the heater selection signal DATA are set to be low so that no heater is driven. Then, in sixteen block periods, the temperature signals from the temperature detecting diodes are first obtained. In the subsequent sixteen block periods, the heater for one nozzle is driven in each block period to obtain the temperature signal from the associated temperature sensor.

According to the inspection sequence described above, the inspection takes twice as long, thirty-two block periods, and noise caused by driving of the heater for one nozzle is superimposed in each block period during obtaining of the temperature signal from the temperature sensor. However, during obtaining of the temperature signal from the temperature detecting diode, superimposition of noise caused by driving of the heater can be avoided.

As described above, the printing element substrate 1 according to this embodiment has a circuit configuration in which the temperature sensor directly below the heater in the wiring layer and the temperature detecting diode provided in the substrate are connected in series with each other. With such a configuration, the temperature sensor and the temperature detecting diode can share the energization switch element (first switch element) and also can share the sensor selecting circuit 257 (first selecting unit). This is because as a result of the temperature sensor and the temperature detecting diode sharing the energization switch element, the temperature sensor and the temperature detecting diode can share the sensor selecting circuit 257 that outputs a signal for controlling turning on and off of the energization switch element. Therefore, the circuit area of the printing element substrate 1 can be reduced, and the substrate cost can be reduced. Note that this embodiment also has an advantage that the density of the nozzles can be increased since the distance between the nozzles can be reduced as a result of the sensor selecting circuit 257 being shared.

Here, a current higher than the current flowing through the signal-outputting switch elements (such as the switch element 245a and the switch element 249a) flows through the energization switch element for applying the constant current to the temperature sensor and the temperature detecting diode, so that the energization switch element has a larger area. According to this embodiment, the number of energization switch elements having a larger area can be reduced, so that the circuit area of the printing element substrate 1 and the substrate cost can be more effectively reduced.

Furthermore, in this embodiment, for example, the temperature obtaining circuit 237a is configured such that the switch element 241a (first switch element), the switch element 245a (second switch element) and the switch element 249 a (third switch element) are turned on in synchronization. That is, the gates of the switch element 241a, the switch element 245a and the switch element 249a are connected to the same wiring to receive the signal from the sensor selecting circuit 257. Therefore, turning on and off of the three switch elements can be controlled with the signal from one sensor selecting circuit 257. The three switch elements are the energization switch element 241a, the switch element 245a for extracting the detection signal from the first terminal of the temperature sensor 105a, and the switch element 249a for extracting the detection signal from the anode of the temperature detecting diode 109a. In other words, the switch element 241a, the switch element 245a and the switch element 249a can also share the sensor selecting circuit 257. Therefore, according to this embodiment, the circuit area of the printing element substrate 1 can be reduced, and the substrate cost can be reduced.

Furthermore, in a case where the constant current circuit is provided on the printing element substrate 1, separate constant current circuits need not be provided to apply a constant current to the temperature sensor and the temperature detecting diode, and a constant current can be applied from one constant current circuit to the temperature sensor and the temperature detecting diode. Therefore, the circuit area of the printing element substrate 1 can be reduced, and the substrate cost can be reduced.

### Second Embodiment

In the first embodiment, an example circuit configuration has been described in which the temperature sensor arranged in association with each nozzle is connected in series with the temperature detecting diode belonging to the same block. That is, the number of temperature sensors and the number of temperature detecting diodes are equal. However, in a second embodiment, an example circuit configuration will be described in which a temperature sensor is arranged in association with each nozzle, and one of the temperature sensors in each group is connected in series with a temperature detecting diode. In the following description, the same components as or the components corresponding to those in the first embodiment will be denoted by the same reference numerals, and descriptions thereof will be omitted. The following description will be mainly focused on differences from the first embodiment.

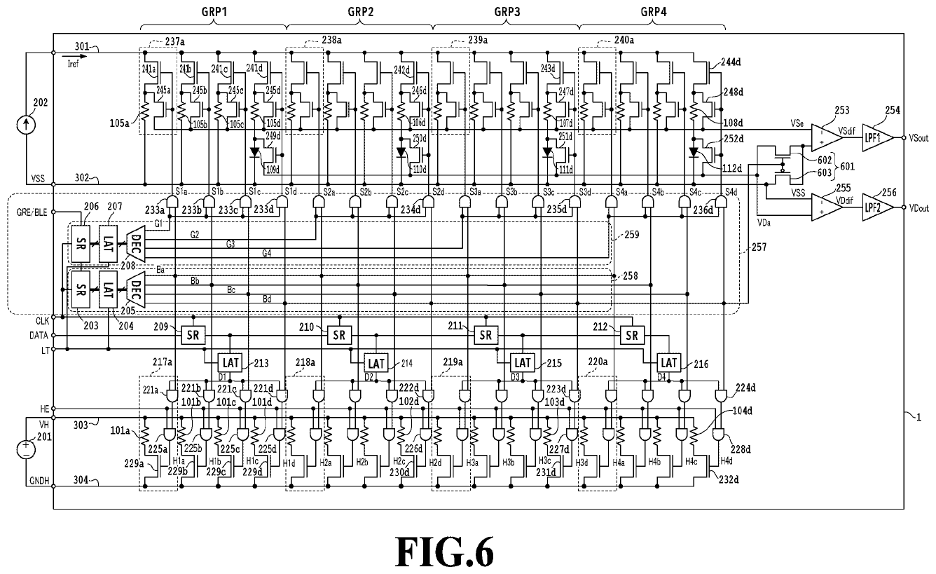

FIG. 6 is a block diagram showing a circuit in which a temperature sensor is arranged in association with each nozzle, and one of the temperature sensors in each group is connected in series with a temperature detecting diode. As shown in FIG. 6, in a printing element substrate 1 according to this embodiment, only the block BLK4 includes temperature detecting diodes 109d to 112d and switch elements 249d to 252d for controlling signal output at the anodes of the temperature detecting diodes 109d to 112d. The printing element substrate 1 according to this embodiment further includes an input signal switch 601 provided at the non-inverting input terminal of the differential amplifier 253. The remainder of the configuration is the same as that in the first embodiment.

In the first embodiment, as shown in FIG. 3, an example configuration has been described in which the same number of temperature detecting diodes 109 to 112 as the number of temperature sensors 105 to 108 are provided. In that case, the temperature sensors and the temperature detecting diodes can be connected in series in a one-to-one correspondence, and the temperature obtaining circuits 237 to 240 for all the nozzles can have the same configuration. However, the temperature distribution obtained by the temperature detecting diodes varies slowly in the direction of the nozzle array. Therefore, the temperature distribution in the direction of the nozzle array does not necessarily need to be obtained at nozzle intervals. That is, the temperature distribution in the direction of the nozzle array does not necessarily need a spatial resolution equivalent to that of the temperature distribution obtained at nozzle intervals.

In view of this, in this embodiment, temperature detecting diodes 109 to 112 are arranged at such intervals that one temperature detecting diode is provided for each group, that is, four nozzles, as shown in FIG. 6. In this embodiment, in each group, the temperature sensor 105d to 108d of the block BLK4 is connected in series with the temperature detecting diode 109d to 112d. Accordingly, the switch elements 249d to 252d for extracting and detecting the potential at the anodes (third terminals) of the temperature detecting diodes 109d to 112d are also provided only in the block BLK4. In the configuration according to this embodiment, again, in a case where the switch element 241d for constant current energization is turned on in the group GRP1, for example, the constant current Iref is applied to the temperature sensor 105d and the temperature detecting diode 109d connected in series with the temperature sensor 105d. However, in a case where any of the switch elements 241a, 241b and 241c is turned on, the constant current Iref is applied to only the associated temperature sensor 105a, 105b or 105c. That is, in the group GRP1, in a case where any of the switch elements 241 is turned on, the constant current Iref is applied to the associated temperature sensor 105. At the same time, in a case where the temperature sensor 105 to which the constant current Iref is applied is the temperature sensor 105d, the constant current Iref is also applied to the temperature detecting diode 109d connected in series with the temperature sensor 105d. The same holds true for the other groups GRP2 to GRP4.

With such a configuration, in obtaining the temperature signal from the temperature sensors of the blocks BLK1 to BLK3 to which the temperature detecting diode is not connected, the signal input to the non-inverting input terminal of the differential amplifier 253 needs to be changed. That is, in obtaining the temperature signal from the temperature sensors of the blocks BLK1 to BLK3, the signal input to the non-inverting input terminal of the differential amplifier 253 needs to be changed from the potential at the anode (third terminal) of the temperature detecting diode to the ground potential VSS. Therefore, in a case where the temperature sensor selected based on the signal on the wiring Bd is not the temperature sensor of the block BLK4, the signal input to the non-inverting input terminal of the differential amplifier 253 needs to be changed. Specifically, the signal input to the non-inverting input terminal of the differential amplifier 253 is changed by the input signal switch 601 (referred to also as a fourth switch element) from the potential at the anode (third terminal) of the temperature detecting diode to the ground potential VSS.

As shown in FIG. 6, the input signal switch 601 is provided at the non-inverting input terminal of the differential amplifier 253. The input signal switch 601 has a function of switching the input to the differential amplifier 253 between the signal that occurs at the anode (third terminal) of the temperature detecting diode 109d and the potential of the grounding wiring 302 according to the signal from the sensor selecting circuit 257. In the following, a configuration and a function of the input signal switch 601 will be described. The input signal switch 601 is formed by an n-channel MOS transistor 602 and a p-channel MOS transistor 603. The gates of the n-channel MOS transistor 602 and the p-channel MOS transistor 603 are connected to each other. One of the source and the drain of the n-channel MOS transistor 602 is connected to the anodes (third terminals) of the temperature detecting diodes 109d to 112d via the switch elements 249d to 252d. The other of the source and the drain of the n-channel MOS transistor 602 is connected to the non-inverting input terminal of the differential amplifier 253. One of the source and the drain of the p-channel MOS transistor 603 is connected to the grounding wiring 302 (ground potential VSS). The other of the source and the drain of the p-channel MOS transistor 603 is connected to the non-inverting input terminal of the differential amplifier 253.

The n-channel MOS transistor 602 and the p-channel MOS transistor 603 are turned on and off in a reverse manner in response to the input signal to the gate. Therefore, in a case where the signal from the sensor selecting circuit 257 is true (High active), the n-channel MOS transistor 602 is turned on, and the p-channel MOS transistor 603 is turned off. As a result, in a case where the temperature detecting diode 109d is selected, for example, the potential signal VDa at the anode (third terminal) of the temperature detecting diode 109d is input to the non-inverting input terminal of the differential amplifier 253. On the other hand, in a case where the signal from the sensor selecting circuit 257 is not true, the n-channel MOS transistor 602 is turned off, and the p-channel MOS transistor 603 is turned on. As a result, the ground potential VSS of the grounding wiring 302 is input to the non-inverting input terminal of the differential amplifier 253.

With the configuration described above, for the pair of the temperature sensor 105d and the temperature detecting diode 109d connected in series with each other, the input signal switch 601 is switched to output the signal that occurs at the third terminal to the non-inverting input terminal of the differential amplifier 253. On the other hand, for the temperature sensors 105a to 105c that are connected to no temperature detecting diode, the input signal switch 601 is switched to output the potential of the grounding wiring to the non-inverting input terminal of the differential amplifier 253. The same holds true for the other groups GRP2 to GRP4.

In this embodiment, in obtaining the temperature signal from the temperature sensors 105a to 105c, 106a to 106c, 107a to 107c and 108a to 108c of the blocks BLK1 to BLK3, the ground potential VSS is input to the non-inverting input terminal of the differential amplifier 253. On the other hand, in obtaining the temperature signal from the temperature sensors 105d to 108d of the block BLK4, the potential at the anode (third terminal) of the temperature detecting diode is input to the non-inverting input terminal of the differential amplifier 253.

With the configuration described above, the temperature signals from the sixteen temperature sensors 105 to 108 and the four temperature detecting diodes 109d to 112d are obtained in the four-by-four block periods.

With the configuration according to this embodiment, compared with the first embodiment, the number of temperature detecting diodes and the number of switch elements for selecting the anodes (third terminals) of the temperature detecting diodes can be substantially reduced. Therefore, the circuit area of the printing element substrate 1 can be further reduced, so that the substrate cost can be further reduced.

Note that in a case where only the temperature signal from the temperature detecting diode is obtained without driving the heater after the printing sequence ends, the detection period can be reduced to four block periods by continuously enabling the wiring Bd in the four block periods and sequentially switching the wiring G1 to G4 to be enabled. In this way, the simultaneity of the substrate temperatures obtained by the four temperature detecting diodes can be increased.

In this embodiment, an example has been described in which sixteen temperature sensors 105 to 108 are divided into four groups each including four temperature sensors, and each group includes one temperature detecting diode. However, the number of temperature sensors, the number of groups and the number of blocks are not limited to this example, and this embodiment can be applied to cases where the number of temperature sensors, groups or blocks is more than or less than the number of temperature sensors, groups or blocks in this example. This embodiment can also be applied to the following case: L temperature sensors are composed of N groups each including M temperature sensors. In that case, the M temperature sensors in each group belong to different M blocks. Furthermore, each of the N groups includes one temperature detecting diode belonging to any one of the blocks, and the temperature detecting diode is connected in series with the temperature sensor in the same group belonging to the same block.

### Third Embodiment

In the first embodiment, an example circuit configuration has been described in which the temperature sensor arranged in association with each nozzle is connected in series with the associated temperature detecting diode. In the second embodiment, an example circuit configuration has been described in which one temperature sensor is arranged in association with each nozzle, and one of the temperature sensors in each group is connected in series with a temperature detecting diode. However, in a third embodiment, an example circuit configuration will be described in which one temperature detecting diode is connected in series with all temperature sensors in each group. In the following description, the same components as or the components corresponding to those in the first embodiment will be denoted by the same reference numerals, and descriptions thereof will be omitted. The following description will be mainly focused on differences from the first embodiment.

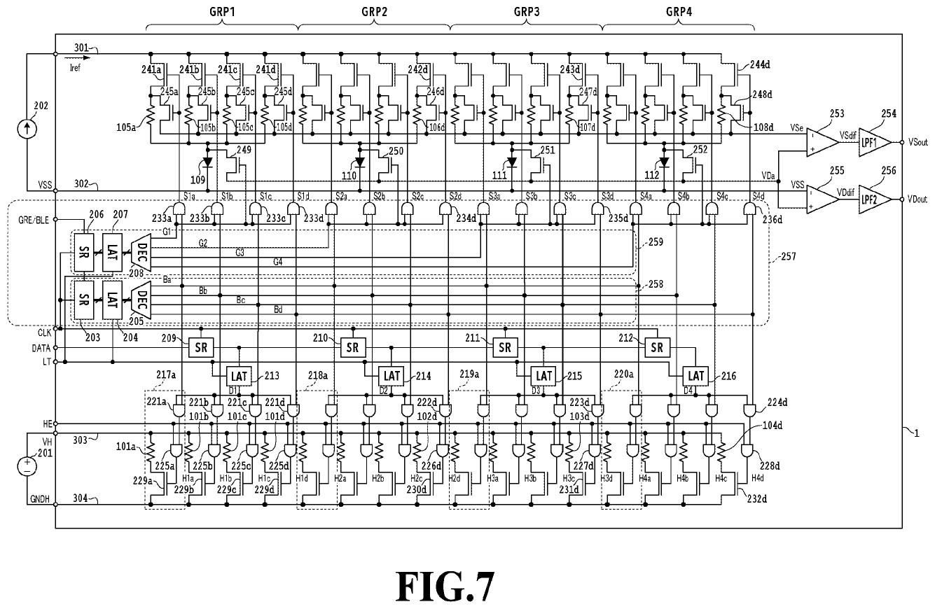

FIG. 7 is a block diagram showing a circuit configuration in which one temperature detecting diode is connected in series with all temperature sensors in each group. The configuration shown in FIG. 7 is the same as the configuration according to the first embodiment except for the temperature detecting diodes 109 to 112 and the switch elements for controlling turning on and off of signal output at the anodes (third terminals) of the temperature detecting diodes 109 to 112.

In the second embodiment, as shown in FIG. 6, an example has been described in which the temperature detecting diodes 109d to 112d are arranged at such intervals that one temperature detecting diode is provided for each group, so that the number of switch elements for selecting the anodes (third terminals) of the temperature detecting diodes 109d to 112d is reduced. In that case, the substrate temperature distribution obtained by the temperature detecting diodes 109d to 112d can have a necessary and sufficient spatial resolution.

However, with the circuit configuration according to the second embodiment, in a case of obtaining the temperature signals from the temperature sensors 105d to 108d and the temperature detecting diodes 109d to 112d at the same time, the output signals from the anodes of the temperature detecting diodes are unstable in the first block period to third block period. Therefore, the temperature signal from only one temperature detecting diode can be obtained while the temperature signals from four temperature sensors in a group are obtained.

In view of this, in this embodiment, as shown in FIG. 7, one of the temperature detecting diodes 109 to 112 is arranged in each group, and all of the four temperature sensors in each group are connected in series with the temperature detecting diode. That is, the terminals (second terminals) on the opposite side to the constant current application-side terminals of the temperature sensors in the same group are connected to common wiring, and the anode (third terminal) of the one temperature detecting diode in the same group is connected to the common wiring.

In this regard, if the potential signal at the anode (third terminal) of the temperature detecting diode 109 to 112 includes a voltage due to the wire resistance, the voltage has an effect on the variation of the output signal VDdif of the differential amplifier 255. To eliminate the effect, the potential signal is extracted by a probe terminal, to which the switch element 249 to 252 is connected, provided at a position closest possible to the p-type semiconductor region serving as the anode of the temperature detecting diode.

In a case where a probe terminal for the anode (third terminal) is provided as described above, in the group GRP1, for example, the wire lengths from the temperature sensors 105a to 105d to the probe terminal in the group are different. Therefore, a potential difference corresponding to the difference in wire length occurs between the potentials at the constant current application-side terminals (first terminals) of the temperature sensors 105a to 105d. This potential difference has an effect on the variation of the output signal VSdif of the differential amplifier 253. However, the variation is superimposed on the output signal VSdif in the form of a direct-current component. In the output signal processing unit 5 shown in FIG. 1, a high pass filter for performing differential processing (not shown) removes the direct-current component included in the sensor output signal VSout, and therefore, the variation does not pose a problem.

With the configuration described above, the temperature signals from the sixteen temperature sensors 105 to 108 and the sixteen (four times four) temperature signals from the four temperature detecting diodes 109 to 112 are obtained in the four-by-four block periods.

Therefore, according to this embodiment, as in the second embodiment, the number of temperature detecting diodes and the number of switch elements for selecting the anodes (third terminals) of the temperature detecting diodes can be substantially reduced, and therefore, the substrate cost can be further reduced. In addition, the substrate temperature can be measured with higher precision than in the second embodiment. That is, the waveform 502 can be obtained four times by the same temperature detecting diode during the same inspection period as in the first embodiment. The output signal processing unit 5 performs averaging of the four waveforms 502, so that the substrate temperature can be measured with higher precision.

In this embodiment, an example has been described in which sixteen temperature sensors 105 to 108 are divided into four groups each including four temperature sensors, and each group includes one temperature detecting diode. However, the number of temperature sensors, the number of groups and the number of blocks are not limited to this example, and this embodiment can be applied to cases where the number of temperature sensors, groups or blocks is more than or less than the number of temperature sensors, groups or blocks in this example. This embodiment can also be applied to the following case: L temperature sensors are composed of N groups each including M temperature sensors. In that case, the M temperature sensors in each group belong to different M blocks. Furthermore, each of the N groups includes one second temperature detecting element, and the second temperature detecting element is connected in series with each of the M first temperature detecting elements in the same group.

This embodiment can also be applied to the following case: L temperature sensors are composed of N groups each including M temperature sensors. In that case, the N groups each include M energization switch elements belonging to different blocks, M temperature sensors belonging to different blocks, and one temperature detecting diode. Each of the M energization switch elements is connected between the first terminal of the temperature sensor belonging to the same block and the power supply wiring 301. The second terminals of the M temperature sensors in the same group are connected to common wiring. The third terminal of the temperature detecting diode is connected to the common wiring.

### Fourth Embodiment

In the first embodiment, an example circuit configuration has been described in which the temperature sensor arranged in association with each nozzle is connected in series with the associated temperature detecting diode. However, in a fourth embodiment, each group includes one energization switch element for applying a constant current to the temperature sensors and the temperature detecting diodes. Furthermore, each block includes one switch element for controlling the output signals at the constant current application-side terminals of the temperature sensors. In the following description, the same components as or the components corresponding to those in the first embodiment will be denoted by the same reference numerals, and descriptions thereof will be omitted. The following description will be mainly focused on differences from the first embodiment.

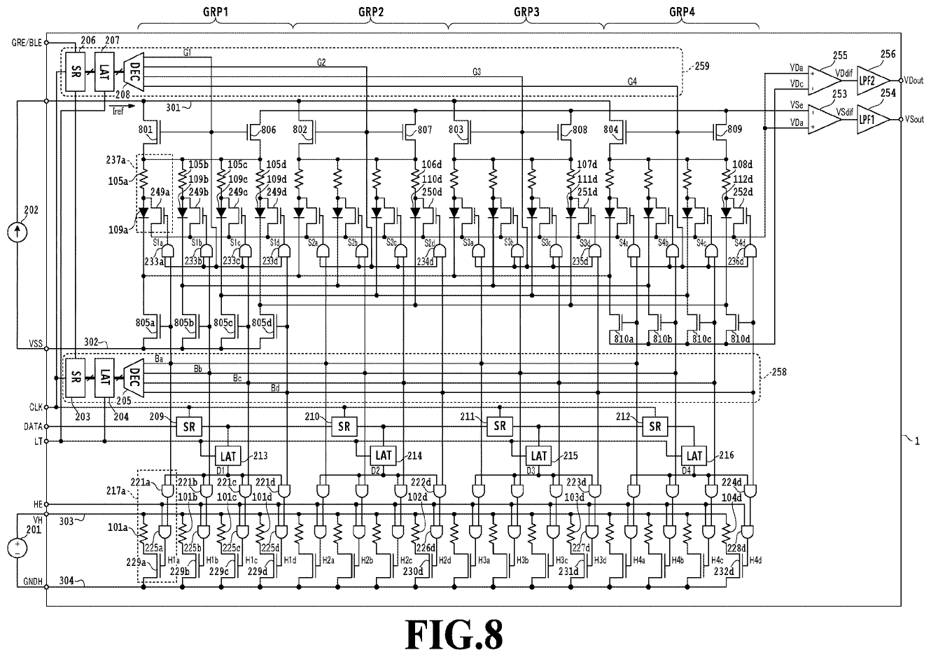

FIG. 8 is a block diagram showing a circuit configuration in which each group includes one switch element for applying a constant current to the temperature sensors and the temperature detecting diodes. The configuration shown in FIG. 8 is the same as the configuration according to the first embodiment except for the switch elements for controlling energization of the temperature sensors and the temperature detecting diodes and the switch elements for controlling signal output at the constant current application-side terminals (first terminals) of the temperature sensors and the cathodes (third terminals) of the temperature detecting diodes.

As shown in FIG. 3, with the configuration of the temperature obtaining circuits 237 to 240 according to the first embodiment, sixteen energization switch elements 241 to 244 are arranged in total, each temperature obtaining circuit including one energization switch element. That is, in the first embodiment, each block includes one energization switch element 241 to 244. However, the energization switch elements 241 to 244 which apply a constant current, have a larger area than the switch elements 245 to 252 for extracting and detecting the potential signal. Therefore, the number of energization switch element is a primary rate-determining factor in reducing the circuit area.

In view of this, in this embodiment, as shown in FIG. 8, on the side toward the power supply wiring 301, the four temperature obtaining circuits in the same group (such as 237a to 237d in GRP1) share one energization switch element 801 to 804. For example, in the group GRP1, the constant current application-side terminals (first terminals) of the four temperature sensors 105 are connected in parallel to one energization switch element 801 in the group. The energization switch element 801 is connected between the constant current application-side terminals (first terminals) of the temperature sensors 105 connected in parallel with each other and the power supply wiring 301. Furthermore, in this embodiment, on the side toward the grounding wiring 302, the four temperature obtaining circuits in the same block (such as 237a to 240a in BLK1) share one energization switch element 805a to 805d (referred to also as a fifth switch element). For example, in the block BLK4, the cathodes (fourth terminals) of the four temperature detecting diodes 109a to 112a in the same block are connected in parallel to one energization switch element 805a in the block. The energization switch elements 805a to 805d are connected between the cathodes (fourth terminals) of the temperature detecting diodes connected in parallel with each other and the grounding wiring 302.

In FIG. 8, one of the energization switch elements 801 to 804 connected to the wiring among the wiring G1 to G4 on which the signal is true (High active) is turned on. Meanwhile, one of the energization switch elements 805a to 805d connected to the wiring among the wiring Ba to Bd on which the signal is true (High active) is turned on. Then, the constant current is applied to the temperature sensor and the temperature detecting diode of the temperature obtaining circuit that is selected as a group and is selected as a block. In this process, the temperature detecting diodes 109 to 112 also have a function of preventing the constant current from flowing back to the temperature sensors that are not selected through the common wiring that connects the energization switch elements 805a to 805d to the cathodes (fourth terminals) of the temperature detecting diodes. That is, the temperature detecting diodes 109 to 112 serve also as blocking diodes.

The wiring G1 to G4 are also connected to switch elements 806 to 809. Therefore, the potential signal VSe that occurs at the constant current application-side terminal (first terminal) of the temperature sensor to which the constant current is applied is output to the inverting input terminal of the differential amplifier 253 through one of the switch elements 806 to 809 that is turned on.

The wiring Ba to Bd are also connected to switch elements 810a to 810d. Therefore, a potential signal VDc that occurs at the cathode (fourth terminal) of the temperature detecting diode to which the constant current is applied is output to the inverting input terminal of the differential amplifier 255 through one of the switch elements 810a to 810d that is turned on.

As in the first embodiment, the AND gate circuits 233 to 236 turn on one of the switch elements 249 to 252 of the block that is enabled in the group that is enabled. Then, through the switch element turned on, the potential signal VDa that occurs at the anode (third terminal) of the temperature detecting diode is output to the non-inverting input terminals of the differential amplifiers 253 and 255.

With the configuration described above, the number of energization switch elements, which is sixteen in the first embodiment, is eight in this embodiment. That is, the number of energization switch elements having a larger area can be reduced to half. On the other hand, the number of switch elements for detecting the potential at the anodes (third terminals) of the temperature detecting diodes is sixteen, which is the same as that in the first embodiment. However, the total number of switch elements for the constant current application-side terminals (first terminals) of the temperature sensors and the cathodes (fourth terminals) of the temperature detecting diodes, which is sixteen in the first embodiment, can be reduced to eight. Therefore, the circuit area of the printing element substrate can be reduced in accordance with the reduction of the number of switch elements, so that the substrate cost can be further reduced.

In this embodiment, an example has been described in which sixteen temperature sensors 105 to 108 are divided into four groups each including four temperature sensors, and each group includes one temperature detecting diode. However, the number of temperature sensors, the number of groups and the number of blocks are not limited to this example, and this embodiment can be applied to cases where the number of temperature sensors, groups or blocks is more than or less than the number of temperature sensors, groups or blocks in this example. This embodiment can also be applied to the following case: L temperature sensors are composed of N groups each including M temperature sensors. In that case, the N groups each include one first switch element, M temperature sensors belonging to different blocks, and M temperature detecting diodes belonging to different blocks and each connected in series with the temperature sensor of the same block. Furthermore, each of the M groups includes one fifth switch element. The first terminals of the M temperature sensors of the same group are connected in parallel to the one first switch element of the group. The first switch element is connected between the first terminals connected in parallel in the group and the power supply wiring 301. The fourth terminals of the N temperature detecting diodes of the same block are connected in parallel to the one fifth switch element of the block. The fifth switch element is connected between the fourth terminals connected in parallel in the block and the grounding wiring.

### Fifth Embodiment

In the first embodiment, an example circuit configuration has been described in which the temperature sensor arranged in association with each nozzle is connected in series with the associated temperature detecting diode. Furthermore, in the fourth embodiment, an example circuit configuration has been described in which the number of energization switch elements for the temperature sensors and the temperature detecting diodes and the number of switch elements for controlling the output signals at the constant current application-side terminals of the temperature sensors are reduced. However, in a fifth embodiment, an example circuit configuration will be described in which the number of switch elements for controlling the output signals at the anodes of the temperature detecting diodes is reduced. In the following description, the same components as or the components corresponding to those in the fourth embodiment will be denoted by the same reference numerals, and descriptions thereof will be omitted. The following description will be mainly focused on differences from the fourth embodiment.

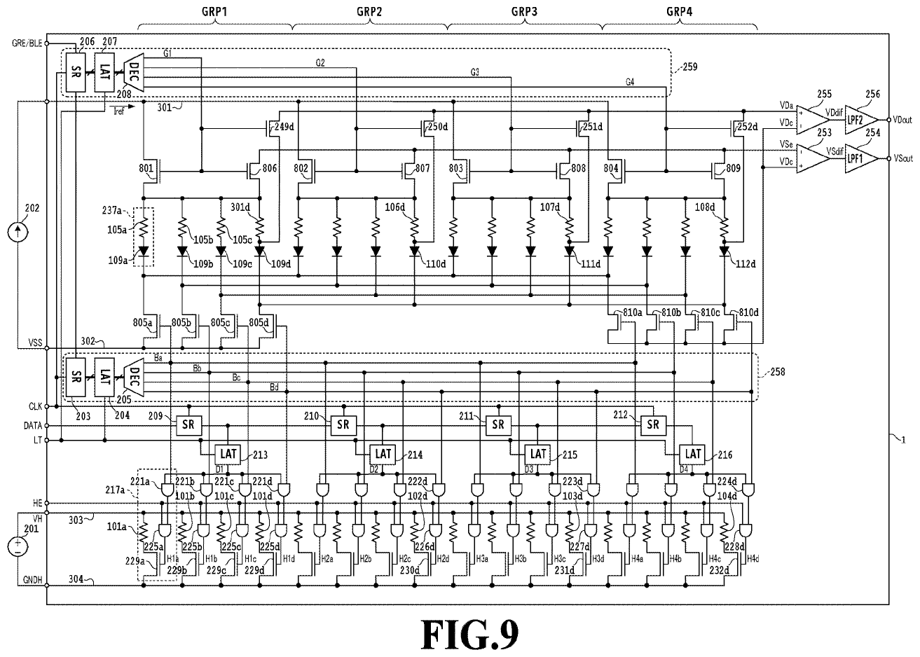

FIG. 9 is a block diagram showing a circuit configuration in which the number of energization switch elements for the temperature sensors and the temperature detecting diodes, the number of switch elements for controlling the output signals at the constant current application-side terminals of the temperature sensors, and the number of switch elements for controlling the output signals at the anodes of the temperature detecting diodes are reduced. The configuration shown in FIG. 9 is the same as the configuration according to the fourth embodiment except for the switch elements for controlling the signal output at the anodes of the temperature detecting diodes and the input signal at the non-inverting input terminal of the differential amplifier 253.

In the fourth embodiment shown in FIG. 8, in the configuration of the temperature obtaining circuits 237 to 240, the number of switch elements 249 to 252 for detecting the anodes (third terminals) of the temperature detecting diodes is sixteen, which is the same as that in the first embodiment. However, as described in the second embodiment, the temperature distribution in the direction of the nozzle array obtained by the temperature detecting diodes does not necessarily need the spatial resolution of the temperature distribution obtained at nozzle intervals. In view of this, in this embodiment, as shown in FIG. 9, the other switch elements for detecting signals at the anodes than four switch elements 249d to 252d of the block BLK4 are omitted. Thus, only four diodes 109d to 112d serve as temperature detecting diodes. However, the diodes in the other temperature obtaining circuits are not omitted since their function as the blocking diode for the constant current is needed.

The switch element 249d can be always in the on state in a case where the temperature sensor 105a to 105d in the group GRP1 to which the temperature detecting diode 109d having the anode connected to the switch element 249d belongs is selected. Therefore, the gate of the switch element 249d is connected to the wiring G1. The same holds true for the switch elements 250d to 252d. Thus, the logical product (AND) of the wiring G1 to G4 enabled and the wiring Ba to Bd enabled does not need to be taken, so that the AND gate circuits 233 to 236 can also be omitted.

In the case of the configuration described above, the function of extracting the potential signals at the anodes (third terminals) of the temperature detecting diodes 109a to 109c for detection, that is, the probe function is lost. That is, in the temperature sensors 105a to 105c, the potential signals that occurs at the terminals (second terminals) connected to the associated temperature detecting diodes cannot be extracted. Instead, the potential signal VDc that occurs at the cathode (fourth terminal) of the temperature detecting diode 109a to 109c is output to the non-inverting input terminal of the differential amplifier 253 through one of the switch elements 810a to 810d that is turned on. Therefore, the output signal VSdif of the differential amplifier 253 is raised by the potential difference between the opposite ends of the diode. However, since the potential difference signal between the anode and the cathode of the diode can be regarded as direct-current in a time scale of the order of microseconds as shown in FIG. 5, the DC component contained in the sensor output signal VSout as the raised portion is removed in the output signal processing unit 5 and thus does not pose a problem. The same holds true for the temperature detecting diodes 110a to 110c, 111a to 111c and 112a to 112c, and the temperature sensors 106a to 106c, 107a to 107c and 108a to 108c.

With the configuration described above, the required number of switch elements for extracting and detecting the potential at the anodes (third terminals) of the temperature detecting diodes, which is sixteen in the fourth embodiment, is reduced to four. In addition, the AND gate circuits 233 to 236 can be omitted.

Therefore, the circuit area of the printing element substrate can be reduced in accordance with the reduction of the switch elements and the AND gate circuits, and the substrate cost can be further reduced.

In this embodiment, an example has been described in which sixteen temperature sensors 105 to 108 are divided into four groups each including four temperature sensors, and each group includes one temperature detecting diode. However, the number of temperature sensors, the number of groups and the number of blocks are not limited to this example, and this embodiment can be applied to cases where the number of temperature sensors, groups or blocks is more than or less than the number of temperature sensors, groups or blocks in this example. This embodiment can also be applied to the following case: L temperature sensors are composed of N groups each including M temperature sensors. In that case, the N groups each include one first switch element, one second switch element, one third switch element, M temperature sensors belonging to different blocks, and M temperature detecting diodes belonging to different blocks and each connected in series with the temperature sensor of the same group. Furthermore, each of the M blocks includes one fifth switch element. The first terminals of the M temperature sensors of the same group are connected in parallel to the one first switch element in the group. The first switch element is connected between the first terminals connected in parallel in the group and the power supply wiring 301. The second switch element is connected between the first terminals connected in parallel in the group and the differential amplifier 253. The third switch element is connected between the third terminal of one of the M temperature detecting diodes and the differential amplifier 255. The fourth terminals of the N temperature detecting diodes of the same block are connected in parallel to the one fifth switch element in the block. The fifth switch element is connected between the fourth terminals connected in parallel in the block and the grounding wiring.

### Other Embodiments

Although the first to fifth embodiments have been described above, the present invention is not limited to the values or forms described above.

In all of the embodiments described above, examples have been described in which the number of nozzles in each nozzle array is sixteen. However, the number of nozzles in each nozzle array may be 512, for example, and the number of blocks may be eight, and the number of groups may be 64.

Furthermore, in the embodiments described above, examples have been described in which the temperature sensor and the temperature detecting diode are arranged in this order viewed from the constant current application side. However, the temperature detecting diode and the temperature sensor may be arranged in this order viewed from the constant current application side.

In the second embodiment, an example configuration has been described in which in each group, one temperature detecting diode is connected in series with the temperature sensor of the block BLK4. However, the one temperature detecting diode may be connected to the temperature sensor of another block BLK1 to BLK3. Furthermore, the temperature detecting diodes may be provided at larger intervals. That is, each temperature detecting diode may be provided for six nozzles or ten nozzles, rather than four nozzles. In that case, the temperature detecting diode can be connected to the temperature sensor of the same block, and thus, some groups include no temperature detecting diode. However, this has no effect on obtaining of the temperature signal and therefore does not pose a problem.

In the third embodiment, each temperature detecting diode is provided for four nozzles. However, the temperature detecting diodes may be provided at larger intervals. For example, each temperature detecting diode may be provided for six nozzles or ten nozzles, rather than four nozzles. In that case, some groups include no temperature detecting diode. However, this has no effect on obtaining of the temperature signal. In addition, the wire length from the temperature sensor to the probe terminal for the anode (third terminal) of the temperature detecting diode may vary in the same group, or the wire length in the same block may vary with the group. However, as described above, this does not pose a problem since the direct-current component of the sensor output signal VSout is removed in the output signal processing unit 5.

In the fifth embodiment, the temperature detecting diodes other than the temperature detecting diodes of the block BLK4 are left and used as blocking diodes for the constant current. However, a plurality of diodes may be connected in series with the temperature detecting diodes of the block BLK4 to improve the output signals at the anodes.

In the embodiments described above, examples have been described in which MOS transistors are used as switch elements. However, bipolar transistors can also be used.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, the circuit area in a printing element substrate of a thermal inkjet printing apparatus can be reduced, and the substrate cost can be reduced.

This application claims the benefit of Japanese Patent Application No. 2025-073563, filed Apr. 25, 2025, which is hereby incorporated by reference herein in its entirety.

What is claimed is:

1. A printing element substrate that ejects ink through a plurality of ejection ports by activating a heating element provided in association with each of the plurality of ejection ports to cause bubbling of the ink in a flow channel, comprising:
a plurality of first temperature detecting elements each disposed in the printing element substrate in association with one of the plurality of heating elements and capable of detecting a temperature from a change in potential difference between opposite ends;
a plurality of second temperature detecting elements disposed in the printing element substrate, connected in series with at least one of the plurality of first temperature detecting elements, and capable of detecting a temperature from a change in potential difference between opposite ends;
a first selecting unit configured to select one of the plurality of first temperature detecting elements; and
a first switch element configured to become a conductive state according to signal from the first selecting unit to energize the first temperature detecting element selected by the first selecting unit and energize the second temperature detecting element connected in series with the first temperature detecting element selected by the first selecting unit.

2. The printing element substrate according to claim 1, further comprising:
power supply wiring connected to a current supply line of a constant current source and configured to apply a constant current to the first temperature detecting element selected by the first selecting unit and also to supply the constant current to the second temperature detecting element in a case where the second temperature detecting element is connected in series with the first temperature detecting element selected by the first selecting unit,
wherein the first switch element is connected between the power supply wiring and the first temperature detecting element and switches between the conductive state and a non-conductive state according to the signal from the first selecting unit.

3. The printing element substrate according to claim 2, wherein in a case where the first switch element becomes the conductive state according to the signal from the first selecting unit, the constant current is applied from the power supply wiring to the first temperature detecting element selected by the first selecting unit, and is also applied to the second temperature detecting element in a case where the second temperature detecting element is connected in series with the first temperature detecting element selected by the first selecting unit, and
in a case where the first switch element becomes the non-conductive state according to the signal from the first selecting unit, the constant current is not applied to the first temperature detecting element, and is also not applied to the second temperature detecting element in a case where the second temperature detecting element is connected in series with the first temperature detecting element.

4. The printing element substrate according to claim 2, further comprising:
a first signal processing unit configured to process a signal based on the potential difference between the opposite ends of the first temperature detecting element; and
a second signal processing unit configured to process a signal based on the potential difference between the opposite ends of the second temperature detecting element.

5. The printing element substrate according to claim 4, wherein in a pair of th first temperature detecting element and the second temperature detecting element connected in series with each other,
the first temperature detecting element has a first terminal connected to the power supply wiring via the first switch element and a second terminal connected to the second temperature detecting element,
the second temperature detecting element has a third terminal that is connected to the second terminal and has a same potential as the second terminal and a fourth terminal that is a terminal on an opposite side to the third terminal,
the first signal processing unit outputs a signal generated based on a signal that occurs at the first terminal and a signal that occurs at the second terminal or the fourth terminal, and
the second signal processing unit outputs a signal generated based on a signal that occurs at the third terminal and a signal that occurs at the fourth terminal.

6. The printing element substrate according to claim 5, further comprising:
a second switch element connected between the first terminal and the first signal processing unit and switching between the conductive state and the non-conductive state according to the signal from the first selecting unit; and
a third switch element connected between the third terminal and the second signal processing unit and switching between the conductive state and the non-conductive state according to the signal from the first selecting unit.

7. The printing element substrate according to claim 6, wherein switching between the conductive state and the non-conductive state of the second switch element and the third switch element associated with the pair of the first temperature detecting element and the second temperature detecting element connected in series with each other, respectively, is in synchronization with switching of the first switch element between the conductive state and the non-conductive state.

8. The printing element substrate according to claim 6, further comprising:
grounding wiring connected to a ground line of the constant current source,
wherein in a case where the second switch element and the third switch element are in the conductive state,
the first signal processing unit outputs a signal generated based on input of the signal that occurs at the first terminal and the signal that occurs at the second terminal or the fourth terminal,
the second signal processing unit outputs a signal generated based on input the signal that occurs at the third terminal and the signal that occurs at the fourth terminal or a potential of the grounding wiring, and
in a case where the second switch element and the third switch element are the non-conductive state, no signal is input to the first signal processing unit and the second signal processing unit.

9. The printing element substrate according to claim 8, wherein the first signal processing unit is formed by a first differential amplifier that generates an output signal obtained by amplifying a difference between the signal that occurs at the first terminal and the signal that occurs at the second terminal or the fourth terminal, and
the second signal processing unit is formed by a second differential amplifier that generates an output signal obtained by amplifying a difference between the signal that occurs at the third terminal and the signal that occurs at the fourth terminal or the potential of the grounding wiring.

10. The printing element substrate according to claim 8, wherein in the pair of the first temperature detecting element and the second temperature detecting element connected in series with each other, the constant current is applied to the first temperature detecting element selected by the first selecting unit and is also applied to the second temperature detecting element connected in series with the first temperature detecting element selected by the first selecting unit, and
for a first temperature detecting element that is not connected to any of the second temperature detecting elements, the constant current is applied to the first temperature detecting element if the first temperature detecting element is selected by the first selecting unit.

11. The printing element substrate according to claim 10, further comprising:
a fourth switch element configured to switch input to the first signal processing unit between the signal that occurs at the third terminal and the potential of the ground wiring,
wherein the fourth switch is switched to
output the signal that occurs at the third terminal to the first signal processing unit for the pair of the first temperature detecting element and the second temperature detecting element connected in series with each other, and
output the potential of the grounding wiring to the first signal processing unit for the first temperature detecting element connected to no second temperature detecting element.

12. The printing element substrate according to claim 8, wherein provided that relation that L=M×N holds, where L, M and N are natural numbers,
the printing element substrate includes L first temperature detecting elements for a nozzle array including L nozzles,
the L first temperature detecting elements are composed of N groups each including M first temperature detecting elements,
the M first temperature detecting elements in each group belong to different M blocks, and
the first selecting unit includes a second selecting unit configured to output a group selection signal for selecting one of the N groups and a third selecting unit configured to output a block selection signal for selecting one of the M blocks.

13. The printing element substrate according to claim 12, wherein each of the N group includes one of the second temperature detecting elements belonging to any one of the blocks, and
the second temperature detecting element is connected in series with the first temperature detecting element in the same group belonging to the same block.

14. The printing element substrate according to claim 12, wherein each of the N groups includes one of the second temperature detecting elements, and
the one second temperature detecting element is connected in series with the M first temperature detecting elements in the same group.

15. The printing element substrate according to claim 12, wherein the N groups each include M first switch elements belonging to different blocks, M first temperature detecting elements belonging to different blocks and one second temperature detecting element in the group,
each of the first switch elements is connected between the first terminal of the first temperature detecting element belonging to the same block and the power supply wiring,
the second terminals of the M first temperature detecting elements in the same group are connected to common wiring, and
the third terminal of the second temperature detecting element is connected the common wiring.

16. The printing element substrate according to claim 12, wherein the N groups each include one first switch element, M first temperature detecting elements belonging to different blocks, and M second temperature detecting elements belonging to different blocks and each connected in series with the first temperature detecting element in the same block,
each of the M blocks includes one fifth switch element,
the first terminals of the M temperature detecting elements in the same group are connected in parallel to the one first switch element in the group,
the first switch element is connected between the first terminals connected parallel in the group and the power supply wiring,
the fourth terminals of the N second temperature detecting elements in the same block are connected in parallel to the one fifth switch element in the block, and
the fifth switch element is connected between the fourth terminals connected in parallel in the block and the grounding wiring.

17. The printing element substrate according to claim 12, wherein the N groups each include one first switch element, one second switch element, one third switch element, M first temperature detecting elements belonging to different blocks, and M second temperature detecting elements belonging to different blocks and each connected in series with the first temperature detecting element in the same block,
each of the M blocks includes one fifth switch element,
the first terminals of the M first temperature detecting elements in the same group are connected in parallel to the one first switch element in the group,
the first switch element is connected between the first terminals connected parallel in the group and the power supply wiring,
the first switch element is connected between the first terminals connected parallel in the group and the power supply wiring,
the second switch element is connected between the first terminals connected in parallel in the group and the first signal processing unit,
the third switch element is connected between the third terminal of one of the M second temperature detecting elements and the second signal processing unit,
the fourth terminals of the N second temperature detecting elements in the same block are connected in parallel to the one fifth switch element in the block, and
the fifth switch element is connected between the fourth terminals connected in parallel in the block and the grounding wiring.

18. The printing element substrate according to claim 5, wherein the first temperature detecting element is a thin film resistor, and
the second temperature detecting element is a diode, the third terminal is an anode of the diode, and the fourth terminal is a cathode of the diode.

19. The printing element substrate according to claim 1, further comprising:
a constant current circuit configured to generate the constant current.

20. A printing head, comprising a printing element substrate configured to eject ink through a plurality of ejection ports by activating a heating element provided in association with each of the plurality of ejection ports to cause bubbling of the ink in a flow channel,
wherein the printing element substrate comprises:
a plurality of first temperature detecting elements each disposed in the printing element substrate in association with one of the plurality of heating elements and capable of detecting a temperature from a change in potential difference between opposite ends;
a plurality of second temperature detecting elements disposed in the printing element substrate, connected in series with at least one of the plurality of first temperature detecting elements, and capable of detecting a temperature from a change in potential difference between opposite ends;
a first selecting unit configured to select one of the plurality of first temperature detecting elements; and
a first switch element configured to become a conductive state according to signal from the first selecting unit to energize the first temperature detecting element selected by the first selecting unit and energize the second temperature detecting element connected in series with the first temperature detecting element selected by the first selecting unit.
